(19) United States
(12) Patent Application Publication
(10) Pub. No.: US 2021/0208929 A1
(43) Pub. Date: Jul. 8, 2021

(54) System And Method For Providing Configurable Communications For A Software Platform On A Per Service Basis

(71) Applicant: n.io INNOVATION, LLC, Broomfield, CO (US)

(72) Inventors: Douglas A. STANDLEY, Boulder, CO (US); Randall E. BYE, Louisville, CO (US); Matthew R. DODGE, Dana Point, CA (US)

(73) Assignee: n.io Innovation, LLC, Broomfield, CO (US)

(21) Appl. No.: 15/777,578

(22) PCT Filed: Nov. 21, 2016
(86) PCT No.: PCT/IB2016/001767

§ 371 Date: May 18, 2018

Related U.S. Application Data
(60) Provisional application No. 62/257,976, filed on Nov. 20, 2015.
(60) Provisional application No. 62/257,971, filed on Nov. 20, 2015.

(51) Int. Cl. G06F 9/48

(52) U.S. Cl. CPC G06F 9/4843

(57) ABSTRACT

A system and method provide a software platform and enable the configuration of the software platform for communications on a per service basis. In one example, the software platform includes a core that interacts with an operating system on a device on which the core is nm and is configured to nm services on the device. Multiple blocks are provided, with each block based on a base block class and customized with task specific processing functionality that can be executed only through one of the plurality of services. Each service is based on a base service class and is configured to run at least some of the blocks within a mini runtime environment provided by the service in order to use the blocks' task specific processing functionality. Each service is individually configured with an input block and an output block that define how the service receives and sends information, respectively.

### CROSS-REFERENCE AND CLAIM OF PRIORITY

This application claims the benefit of U.S. Provisional Application Ser. No. 62/257,971, filed on Nov. 20, 2015, and entitled SYSTEM AND METHOD FOR PROVIDING CONFIGURABLE COMMUNICATIONS FOR A SOFTWARE PLATFORM ON A PER SERVICE BASIS, and U.S. Provisional Application Ser. No. 62/257,976, filed on Nov. 20, 2015, and entitled SYSTEM AND METHOD FOR MONITORING AND ACTUATING ELECTRICAL COMPONENTS USING A CONFIGURABLE SOFTWARE PLATFORM INSTANCE, both of which are incorporated by reference herein in their entirety. This application is related to PCT application PCT/IB2016/01184.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4A illustrates one embodiment of a workflow that may be used to create and configure a NIO platform;

FIG. 4B illustrates one embodiment of a user's perspective of a NIO platform;

FIGS. 5-7 illustrate embodiments of systems formed by interconnected NIO platforms;

FIGS. 8A-8C illustrate embodiments of how a service or set of services may be distributed across multiple NIO platforms;

FIG. 9 illustrates one embodiment of NIO platforms from the system of FIG. 7 arranged in a hierarchy of a mother node, a supervisor node, and an edge node;

FIG. 10 illustrates one embodiment of a method that may be used to define and create a system of NIO platforms;

FIG. 11 illustrates another embodiment of a system formed by interconnected NIO platforms;

FIG. 12 illustrates one embodiment of a different perspective of the NIO platform instance of FIG. 3B;

FIG. 13 illustrates one embodiment of a hierarchical flow that begins with task specific functionality and ends with NIO platform instances;

FIG. 14 illustrates another embodiment of a system formed by interconnected NIO platforms;

FIG. 15 illustrates one embodiment of the system of FIG. 11 with some of the NIO platforms grouped into communication clusters;

FIG. 16 illustrates one embodiment of a service that may be configured with various input and output blocks;

FIGS. 17-19 illustrate different embodiments of systems of NIO platforms configured with input and output blocks for communication;

FIG. 20A illustrates one embodiment of a method that may be executed to configure a service for communication;

FIG. 20B illustrates one embodiment of a method that may be executed by a NIO platform;

FIG. 20C illustrates one embodiment of a method that may be executed by a service;

FIG. 21 illustrates one embodiment of an environment showing how functionality embodied in services and blocks can be distributed to different hardware environments;

FIGS. 22A-22D illustrate embodiments of methods that can be applied within the environment of FIG. 21;

FIG. 23 illustrates one embodiment of an environment in which a NIO platform may monitor one or more electrical components;

FIG. 24 illustrates one embodiment of a method that may be executed by the NIO platform of FIG. 23;

FIG. 25 illustrates one embodiment of an electrical component monitoring and actuation system that uses a single NIO platform;

FIGS. 26-28 illustrate embodiments of services that may be used by the NIO platform of FIG. 25;

FIGS. 29A and 29B illustrate an alternate embodiment of the service of FIG. 28;

FIG. 30 illustrates one embodiment of an electrical component monitoring and actuation system that uses multiple NIO platforms;

FIG. 31 illustrates one embodiment of an electrical component monitoring system that uses at least one NIO platform to monitor a power panel;

FIG. 32 illustrates one embodiment of a service that may be used by the NIO platform of FIG. 31 to monitor device metrics of a device on which the NIO platform is running; and

FIGS. 33A and 33B illustrate embodiments of a GUI that may be produced using real time data obtained by the NIO platform of FIG. 31.

### DETAILED DESCRIPTION

The present disclosure is directed to a system and method for providing configurable communications for services and platform instances. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, now issued as U.S. Pat. No. 9,454,385, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

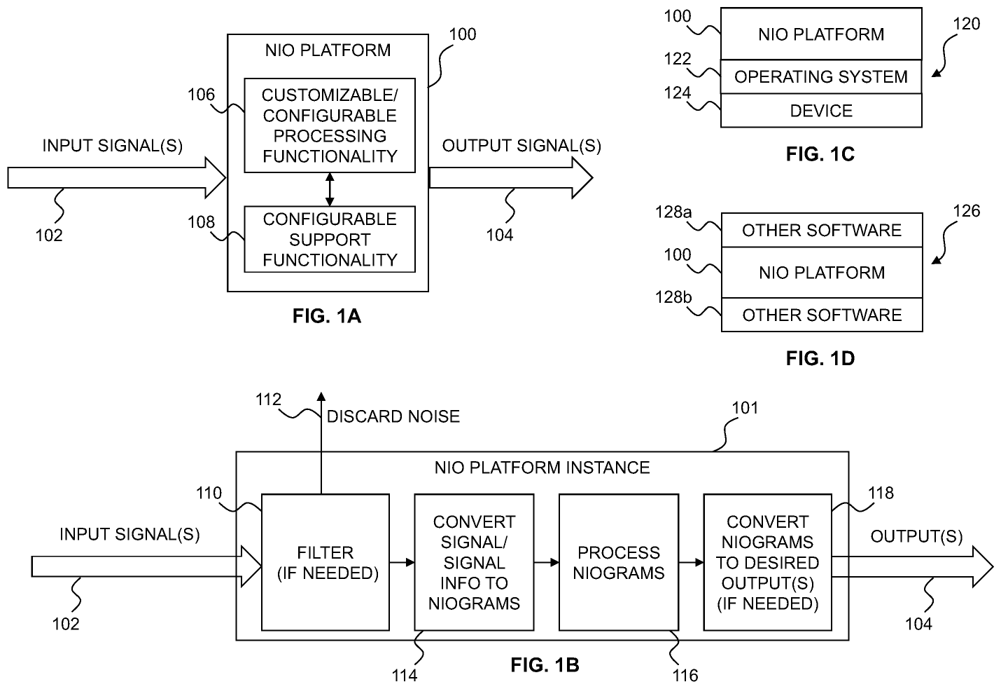

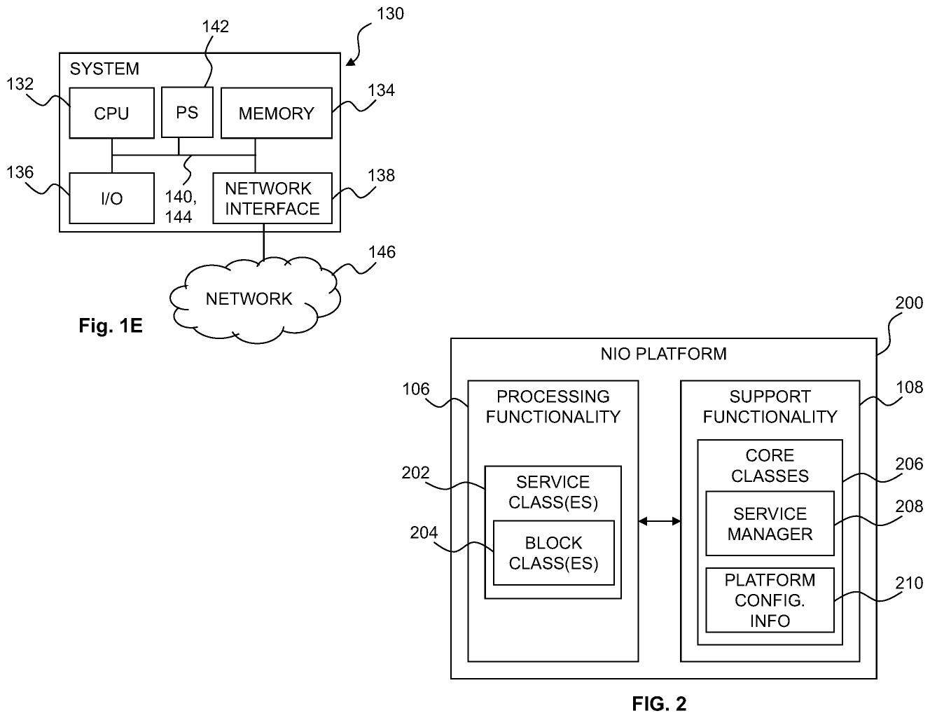

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

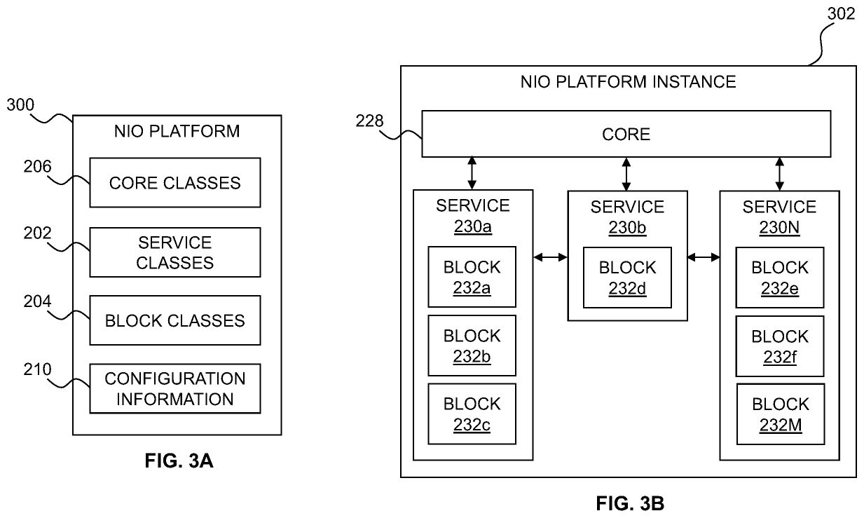

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

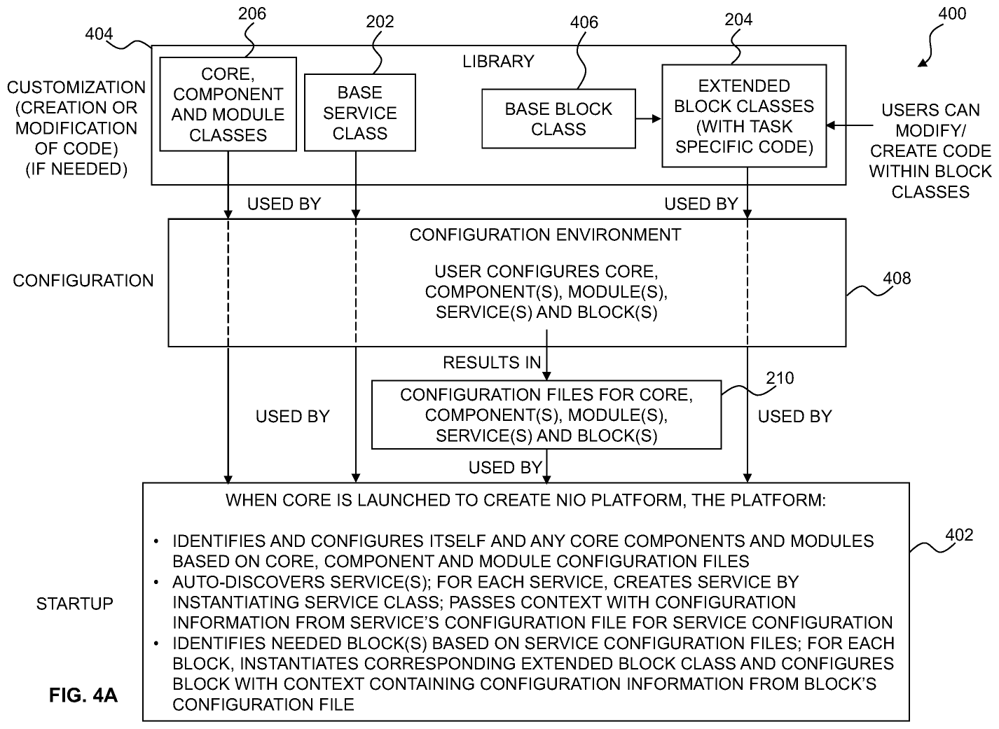

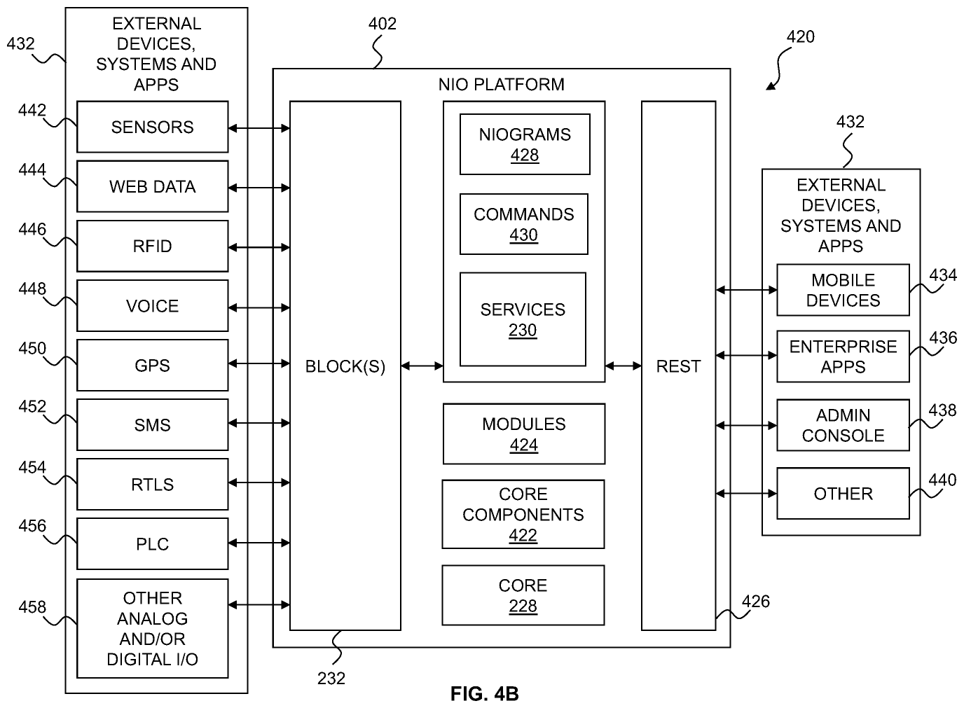

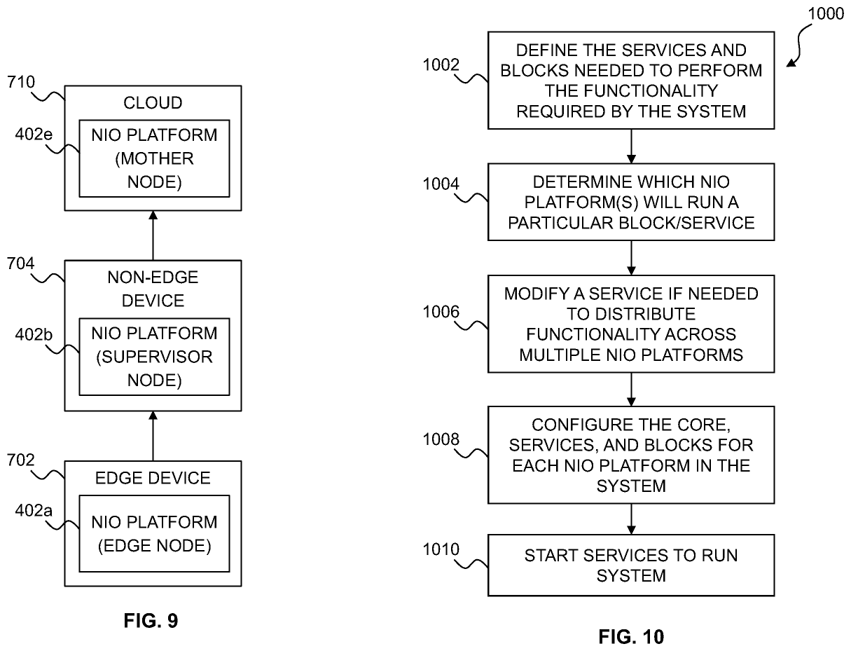

Referring to FIG. 4A, a diagram 400 illustrates one embodiment of a workflow that runs from creation to launch of a NIO platform 402 (which may be similar or identical to the NIO platform 100 of FIG. 1A, 200 of FIG. 2, and/or 300/302 of FIGS. 3A and 3B, as well as 900 of FIGS. 9A and 9B of previously referenced U.S. patent application Ser. No. 14/885,629). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (such as the REST interface 908, 964 disclosed in FIGS. 9A and 9B of previously referenced U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

Referring to FIG. 4B, one embodiment of an environment 420 illustrates a user's perspective of the NIO platform 402 of FIG. 4A with external devices, systems, and applications 432. From the user's perspective, much of the functionality of the core 228, which may include core components 422 and/or modules 424, is hidden. Various core components 422 and modules 424 are discussed in greater detail in previously referenced U.S. patent application Ser. No. 14/885,629 and are not described further in the present example. The user has access to some components of the NIO platform 402 from external devices, systems, and applications 432 via a REST API 426. The external devices, systems, and applications 432 may include mobile devices 434, enterprise applications 436, an administration console 438 for the NIO platform 402, and/or any other external devices, systems, and applications 440 that may access the NIO platform 402 via the REST API.

Using the external devices, systems, and applications 432, the user can issue commands 430 (e.g., start and stop commands) to services 230, which in turn either process or stop processing niograms 428. As described above, the services 230 use blocks 232, which may receive information from and send information to various external devices, systems, and applications 432. The external devices, systems, and applications 432 may serve as signal sources that produce signals using sensors 442 (e.g., motion sensors, vibration sensors, thermal sensors, electromagnetic sensors, and/or any other type of sensor), the web 444, RFID 446, voice 448, GPS 450, SMS 452, RTLS 454, PLC 456, and/or any other analog and/or digital signal source 458 as input for the blocks 232. The external devices, systems, and applications 432 may serve as signal destinations for any type of signal produced by the blocks 232, including actuation signals. It is understood that the term “signals” as used herein includes data.

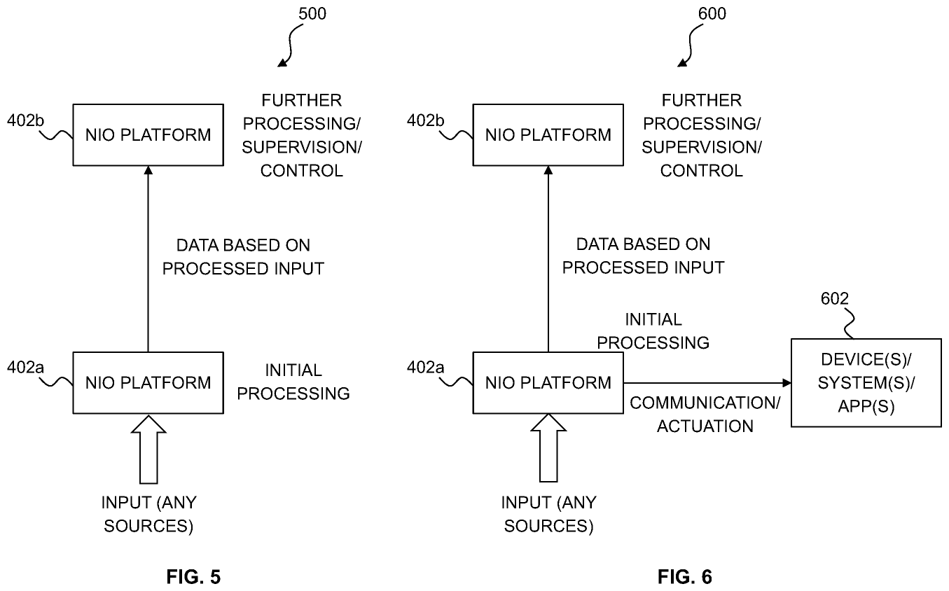

Referring to FIG. 5, one embodiment of a system 500 illustrates two NIO platforms 402a and 402b organized in a tiered or hierarchical arrangement within which real time processing can be performed. Within the system 500, the NIO platform 402a feeds into the NIO platform 402b. Although not shown, it is understood that the communications may be two way, with each of the NIO platforms 402a and 402b sending information (e.g., data and/or commands) to and receiving information from the other of the NIO platforms. For purposes of example, the NIO platform 402a is on an edge device for the system 500 and the NIO platform 402b is not on an edge device.

As described in previous embodiments, each NIO platform 402a and 402b uses the same basic core 228, but can be configured with different core components 912, modules 904, and/or services 230 with corresponding blocks 232. This configurability enables the NIO platform to serve as a single platform solution for the system 500 while supporting highly flexible distribution of the system's processing capabilities. For example, depending on which of the NIO platforms 402a and 402b is selected to run a particular service, particular processing functionality in the system 500 can be moved out to the edge or moved away from the edge as desired. Accordingly, the NIO platform can be used in multiple locations of the system 500 and the functionality of a particular one of the NIO platforms within the system 500 can be configured as desired.

By deploying the NIO platform 402a on an edge device, the fully configurable processing provided by the NIO platform 402a can be used to reduce and/or eliminate the need to transfer data for decision making to another device (e.g., a device on which the NIO platform 402b is running). This not only reduces network traffic, but also means that decisions can be made more quickly as the NIO platform 402a operating at the edge can be configured to make decisions and act on those decisions without the additional temporal overhead that would be required for the round trip transmission time that would be imposed by communications with the NIO platform 402b located on another device. If needed or desired, data can be transferred away from the edge and deeper into the system 500.

The configurability of the NIO platforms 402a and 402b in the system 500 may reduce and/or eliminate the need for customized hardware and/or software needed for particular tasks. The development of such hardware/software is often an expensive and time consuming task, and the development cycle may have to be repeated for each particular device that is to be integrated into or coupled to the system 500. For example, a particular server application may need to interact with different interfaces and/or different operating system running on different devices, and so multiple versions of the same software may be created.

In contrast, because the NIO platform can be configured as desired, adapting a particular service to another interface may be as simple as exchanging one block for another block and setting some configuration values. Furthermore, even though the services can be completely different on different NIO platforms, the use of a standard interface across the NIO platforms provides a consistent environment to users regardless of the services to be run. This enables a user familiar with the interface to configure a NIO platform for its particular task or tasks relatively easily.

Furthermore, because blocks can be reused and existing blocks can be modified, creating a service for a particular task may leverage existing assets. If new blocks are created, they can be used in other instances of the NIO platform. Therefore, each deployment of a particular configuration of the NIO platform 402 may result in a larger library of blocks, which in turn may lessen the amount of effort required for the next deployment. This is particularly true in cases where the next deployment has substantial similarities to the current deployment, such as deployments in different locations that perform similar or identical operations (e.g., manufacturing or agriculture operations).

Accordingly, the NIO platform 402a receives external input that may be any type(s) of input for which the NIO platform 402a is configured. The external input comes from one or more external devices, systems, and/or applications (not shown). As the NIO platform 402a is an edge device in the present example, the input will not be exclusively from another NIO platform, although some of the input may be from another NIO platform. The NIO platform 402a processes the input and then passes data based on the processed input to the NIO platform 402b. Depending on the configuration of the NIO platform 402a, the processing can range from simple (e.g., simply inserting the input into a niogram for forwarding) to complex (e.g., executing multiple related services with complex instructions). The NIO platform 402b can then perform further processing if needed.

This tiered system enables the NIO platform 402a to perform its functions at the point of input into the system 500, rather than having to pass the input to the NIO platform 402b for processing. When the NIO platform 402a is located on an edge device, this means that the input can be processed at the edge based on the particular configuration of the NIO platform 402a.

Referring to FIG. 6, one embodiment of a system 600 illustrates the two NIO platforms 402a and 402b of FIG. 5 and one or more devices, systems, and/or applications 602. As described with respect to FIG. 5, the NIO platforms 402a and 402b are organized in a tiered arrangement. As shown, the NIO platform 402a is an edge device and can directly actuate the device 602. This means that the processing performed on the input at the edge, which may include input from the device 602, can be used to actuate the device 602 or another device, system, or application. By configuring the services 230 on the NIO platform 402a to handle whatever logic may be desired with respect to the device 602, the actuation of the device 602 directly from the NIO platform 402a can occur in real time without introducing additional transmission time.

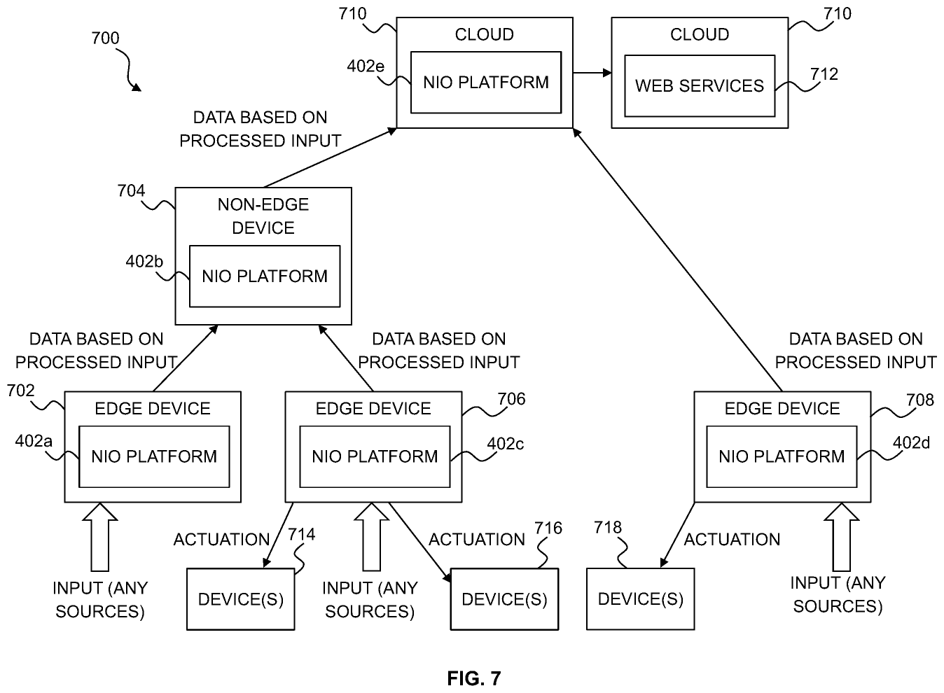

Referring to FIG. 7, one embodiment of a system 700 illustrates the two NIO platforms 402a and 402b of FIG. 5. The system 700 also includes additional NIO platforms 402c, 402d, and 402e. The NIO platforms 402a, 402c, and 402d are running on edge devices 702, 706, and 708, respectively. The NIO platform 402b is running on a non-edge device 704. The NIO platform 402e is running on a server/distributed server system (e.g., a cloud) 710.

The system 700 further includes devices 714, 716, and 718 (which may represent one or more devices, systems, and/or applications as shown in FIG. 6), as well as web services 712 running in the cloud, although these components may not be included in the system itself in embodiments where the NIO platforms are viewed as the system. In some embodiments, some or all of the web services 712 may be provided by the NIO platform 402e, while in other embodiments the web services 712 may be separate from the NIO platform 402e.

For purposes of example, the NIO platforms 402a, 402c, and 402d are referred to as being located on edge devices. More specifically, any NIO platform in the present example that is positioned to directly interface with a device other than a NIO platform is referred to as an edge platform or running on an edge device, while any NIO platform that only interfaces with other NIO platforms or the web services 712 for output is not an edge platform. Although not shown, it is understood that multiple instances of the NIO platform may be run on a single device. For example, the NIO platforms 402a and 402c may be run on one device, rather than on the two devices 702 and 706.

The NIO platforms 402a and 402c are configured to receive input from any source(s), process the input, and pass data based on the input to the NIO platform 402b. The NIO platform 402b is configured to process the received input and pass data based on the input to the NIO platform 402e. The NIO platform 402d is configured to receive input from any source(s), process the input, and pass data based on the input to the NIO platform 402e. The NIO platform 402e is configured to process the input and pass data based on the input to the web services 712 for output as a message (e.g., an email, SMS, or voice message), to a display (e.g., as a webpage), a database, and/or any other destination. It is understood that additional NIO platforms may be present in the system 700.

The arrows representing communication illustrate the general flow of data “up” through the tiers of the system 500 and “down” to the devices 714, 716, and 718 for actuation purposes. However, although the communications are illustrated as one way, it is understood that two way communications are likely to occur. For example, the NIO platforms will likely communicate with the NIO platforms at lower levels (e.g., the NIO platform 402e with the NIO platform 402b), and such communications may include configuration changes to the core 228, services 230, or blocks 232 of a particular NIO platform, commands to perform certain actions, actuation commands to be passed through to one of the devices 714, 716, or 718, and/or requests for data. Accordingly, depending on how the NIO platforms 402a-402e are configured and the capabilities of the devices on which the NIO platforms 402a-402e are running, the communications used with the system 700 may range from the simple to the complex.

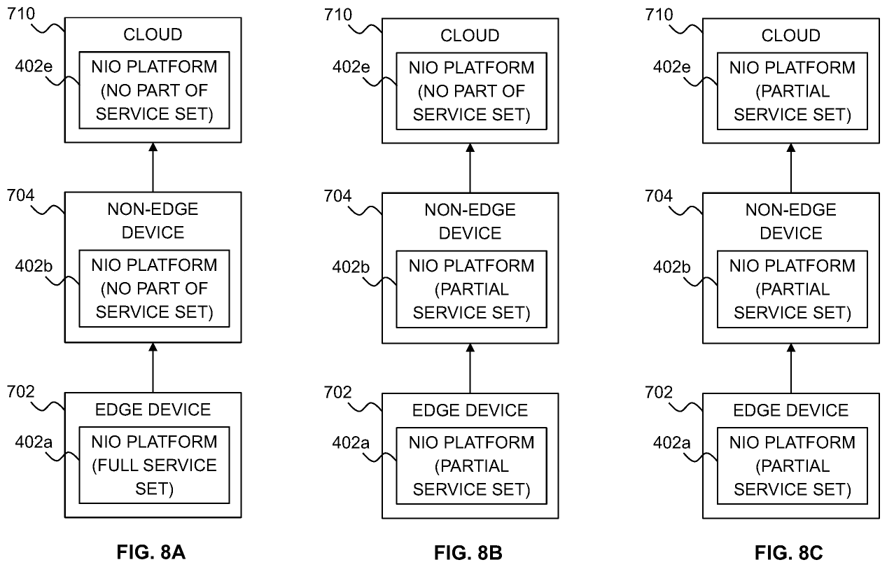

FIGS. 8A-8C illustrate embodiments of how a set of services 230 may be assigned to a single NIO platform or distributed among multiple NIO platforms. One advantage provided by using multiple instances of a single configurable platform to form a system such as the system 700 of FIG. 7 is that the system's functionality may be distributed relatively easily in many different ways simply by configuring the various NIO platforms as desired. It is understood that the service set may actually be a single service, but will often include multiple services that work together to accomplish a particular task. Accordingly, the following examples apply equally to a single service that can be divided into multiple services. The NIO platforms 402a, 402b, and 402e of FIG. 7 are used for purposes of example, with the set of services being responsible for receiving the input, performing defined processing tasks, and then producing a final output.

Referring specifically to FIG. 8A, the entire set of services is located on the NIO platform 402a. In this embodiment, the NIO platform 402a performs all the functions of receiving the input, performing the defined processing tasks, and producing the final output. The final output may include sending an actuation signal to a device, sending data to the NIO platform 402b, or waiting for additional input (e.g., not sending anything out). It is understood that the set of services may also be horizontally distributed (e.g., between two or more edge instances).

Referring specifically to FIG. 8B, the set of services is divided between the NIO platform 402a and the NIO platform 402b. In this embodiment, the NIO platform 402a would be responsible for receiving input. The functions of performing the defined processing tasks and producing the final output may be split between the NIO platforms 402a and 402b in many different ways. For example, the NIO platform 402a may perform part of the processing and send data to the NIO platform 402b. The NIO platform 402b may then perform additional processing and produce the final output.

In another example, the NIO platform 402a would be responsible for receiving input and would simply forward the input data to the NIO platform 402b. The NIO platform 402b would then perform the defined processing tasks and produce the final output. In yet another example, the NIO platform 402a would be responsible for receiving input and would forward the input data to the NIO platform 402b. The NIO platform 402b would then perform the defined processing tasks and send the processed data back to the NIO platform 402a, which would produce the final output.

Referring specifically to FIG. 8C, the set of services is divided among the NIO platform 402a, the NIO platform 402b, and the NIO platform 402e. In this embodiment, the NIO platform 402a would be responsible for receiving input. The functions of performing the defined processing tasks and producing the final output may be split among the NIO platforms 402a, 402b, and 402e in many different ways. For example, the NIO platform 402a may perform part of the processing and send data to the NIO platform 402b. The NIO platform 402b may then perform additional processing and send the processed data to the NIO platform 402e. The NIO platform 402e may perform additional processing and produce the final output or may simply produce the final output with minimal processing.

In another example, the NIO platform 402a would be responsible for receiving input and would forward the input data to the NIO platform 402b. The NIO platform 402b may be configured to process the data and then send the processed data to the NIO platform 402e for the final output. In yet another example, the NIO platform 402a would be responsible for receiving the input and performing initial processing, and would then send the processed data to the NIO platform 402b. The NIO platform 402b may be configured to simply pass the received data on to the NIO platform 402e for further processing and the final output. It is understood that the final output may be produced by any of the NIO platforms 402a, 402b, and 402e and sent to any of the other NIO platforms.

Accordingly, as illustrated by FIGS. 8A-8C, the use of the NIO platform in a multi-tiered arrangement enables services to be distributed as desired. For example, the device 702 on which the NIO platform 402a is running may have limited processing resources available (e.g., the device 702 may have limited CPU and/or memory resources), while the device 704 may have considerably more processing resources. In such an embodiment, the services may be divided so as much processing as possible is performed on the device 702, and the remainder is moved to the device 704. In another example, the device 702 may be capable of performing all the needed processing, and so may be configured to provide all of the processing and the final output. If the device 702 is capable of performing all the needed processing, configuring it to do so may result in less data being sent to the device 704, which may lower the amount of bandwidth needed for such data transfers (depending on the output of the NIO platform 402a). This can be particularly beneficial if the amount of bandwidth is relatively limited and/or shared by other devices.

The interchangeability of the NIO platforms, where a primary NIO platform can be replaced by a backup NIO platform with the same configuration, also makes the provision of failover or backup platforms relatively simple. For example, referring again to FIG. 7, the NIO platform 402a may be a backup or failover platform for the NIO platform 402c. In this example, the NIO platform 402a may not have any inputs or may have the exact same inputs as the NIO platform 402c. The NIO platform 402a or the NIO platform 402b would monitor the NIO platform 402c and, if the NIO platform 402c fails or becomes unresponsive, the NIO platform 402a would take over some or all of the functionality provided by the NIO platform 402c.

In another example, the NIO platform 402a may aid the NIO platform 402c if the NIO platform 402c receives an input data surge that it is unable to handle with its current processing capabilities. The NIO platform 402a would handle the overflow processing in such cases. Once the surge subsides, the NIO platform 402c would no longer need help handling the overflow processing and the NIO platform 402a could return to a standby mode.

In another example, the NIO platform 402a may be configured to run services that are also configured to be run on multiple other NIO platforms. This enables the single NIO platform 402a to aid different NIO platforms as the need arises. For example, the NIO platform 402a may be running on a relatively powerful device that matches the processing resources of the other devices on the NIO platforms are running, which in turn enables the NIO platform 402a to aid multiple other NIO platforms simultaneously. This allows a relatively powerful device to be used to run a backup, failover, and/or overflow NIO platform for multiple other NIO platforms. As the NIO platform 402a can be configured with whatever services are desired, this provides a very flexible solution that can be easily reconfigured to match changes in the configurations of the other NIO platforms and ensure continued support.

Referring to FIG. 9 and with continued reference to FIG. 7, one embodiment of the system 700 organizes the various NIO platforms 402a-402e in an arrangement of edge nodes, a supervisor node, and a mother node. In this example, the NIO platforms 402a, 402c, and 402d are edge nodes, the NIO platform 402b is a supervisor node, and the NIO platform 402e is a mother node. This hierarchy is shown in FIG. 9 for the NIO platforms 402a, 402b, and 402e.

For purposes of example, the edge nodes provided by the NIO platforms 402a, 402c, and 402d are distributed around a manufacturing facility. The NIO platforms 402a, 402c, and 402d connect to sensors, process all sensor data, and perform any local actuations (e.g., turning an LED on or off, or actuating a motor). The edge nodes are generally located out in the facility and so may be distributed based on logical locations for edge nodes within that facility.

The supervisor node provided by the NIO platform 402b monitors some or all of the edge nodes (only the NIO platforms 402a and 402c in FIG. 7) and their services. The NIO platform 402b detects when a primary node goes down and commands a backup node to take over. The supervisor node may also aggregate data from the NIO platforms being supervised, as well as make decisions that require data from multiple NIO platforms. The supervisor node may also handle any internet actuations (e.g., publish to a socket or save data to a cloud or local database). In some embodiments, the supervisor node may perform its actuations directly, while in other embodiments the supervisor node may perform its actuations via the mother node. The supervisor node may be located in different places, such as on a server local to the manufacturing facility or in the cloud.

The mother node provided by the NIO platform 402e monitors external access to the supervisor node and monitors that the supervisor node is running. The mother node is generally located in the cloud, although on site placement is also possible.

This arrangement of NIO platforms enables the formation of tiered systems where higher level NIO platforms can monitor lower level NIO platforms. The lowest level NIO platforms are edge nodes that interface with the devices, systems, and/or applications that are outside of the NIO platform network. Adding additional tiers of NIO platforms may enable the control structure to be extended with additional granularity. It is understood that the processing described in the preceding examples, as well as the communications between NIO platforms, may occur in real time. A real time system created using NIO platforms arranged in a tiered fashion as described herein is highly adaptable.

Referring to FIG. 10, a method 1000 illustrates one embodiment of a process that may be executed to create a system of NIO platforms, such as the system 700 of FIG. 7. It is understood that the method 1000 may be executed over a period of time and may be iterative in nature, with steps being repeated as needed until the overall method has been performed.

In step 1002, the services 230 and blocks 232 that are needed to perform the system's functionality are defined. The particular services 230 and blocks 232 may vary widely across different systems due to the various requirements of a particular system. For example, a system for process control in a manufacturing facility will have very different requirements compared to an agricultural control system or a point of sale/inventory system. While many systems will have similar high level requirements (e.g., the need for real time processing, communication, and actuation) and will use the same basic NIO platform architecture to meet those requirements, the particular services 230 and blocks 232 will likely be significantly different for each system.

In step 1004, a determination is made as to which NIO platform in the system 700 will run a particular block 232 and/or service 230. This step may include an analysis of the processing capabilities of various devices on which the NIO platforms are to be run. This allows the blocks 232 and/or services 230 to be distributed to take advantage of available processing resources. Alternatively, devices may be selected for particular NIO platforms based on the processing requirements imposed by the services 230 assigned to that particular NIO platform. Accordingly, step 1004 may be approached in different ways depending on such factors as whether the devices to be used can be selected or whether already installed devices must be used.

In step 1006, one or more of the services 230 may be modified if needed. For example, if a service 230 defined in step 1002 would be more efficient if distributed across multiple NIO platforms or if the service 230 as originally designed is too resource intensive for a particular device, the service 230 may be redesigned as multiple separate but connected services. Step 1006 may be omitted if not needed. In step 1008, the core 228, services 230, and blocks 232 for each NIO platform within the system 700 are configured. In step 1010, the service 230 are started to run the system 700.

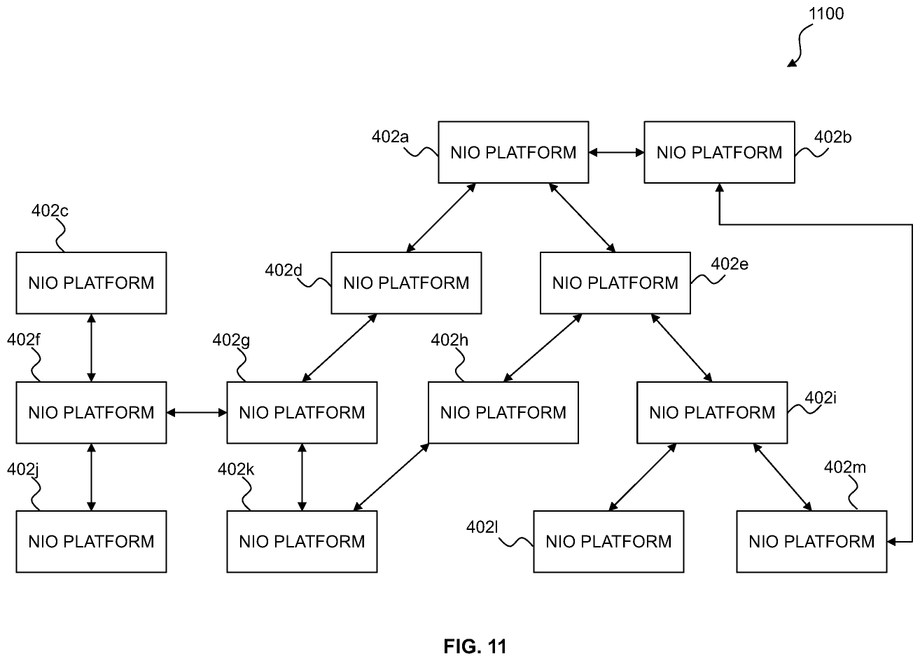

Referring to FIG. 11, one embodiment of a system 1000 includes NIO platforms 402a-402m. The various NIO platforms 402a-402m may be configured identically or each of the NIO platforms 402a-402m may have a different configuration. As shown in FIG. 11, there are many possible connections between NIO platforms in the tiered system 1100, including vertical connections between higher/lower tiered NIO platforms and horizontal connections between NIO platforms in the same tier. As shown by the direct connection between NIO platforms 402b and 402m, intermediate tiers may be bypassed if desired. Services may be distributed in many different ways throughout the system 1100.

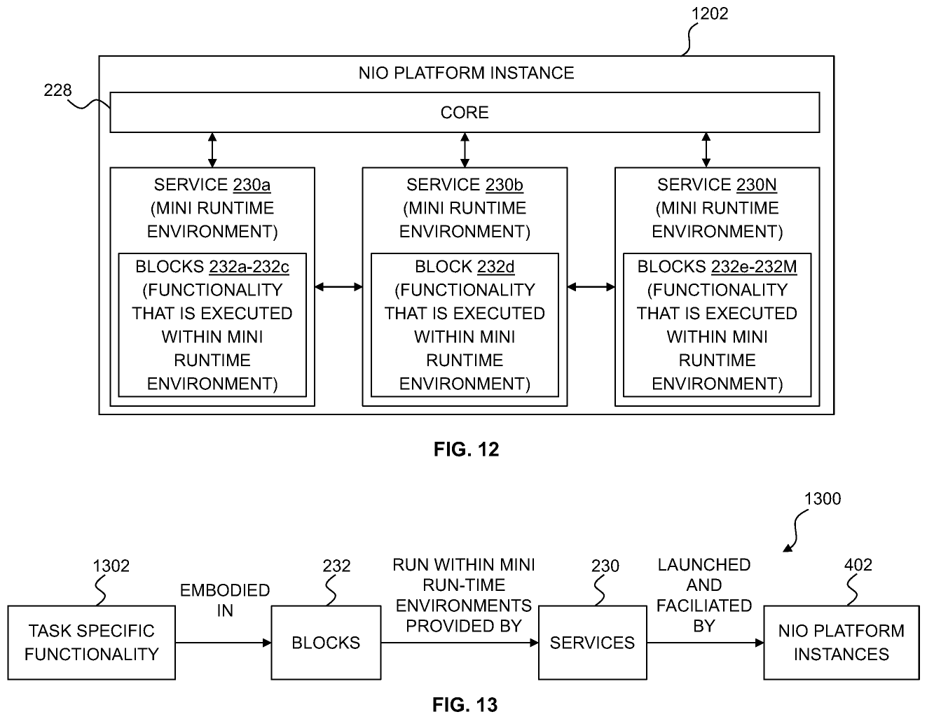

Referring to FIG. 12, one embodiment of a NIO platform instance 1202 illustrates a different perspective of the NIO platform instance 402 of FIG. 3B. The NIO platform instance 1202 (which may be similar or identical to the NIO platform 100 of FIG. 1A, 200 of FIG. 2A, 300 of FIG. 3A, and/or 402 of FIGS. 4A and 4B) is illustrated from the perspective of the task specific functionality that is embodied in the blocks. As described in previously referenced U.S. patent application Ser. No. 14/885,629, services 230 provide a framework within which blocks 232 are run, and a block cannot run outside of a service. This means that a service 230 can be viewed as a wrapper around a particular set of blocks 232 that provides a mini runtime environment for those blocks.

From this perspective, a service 230 is a configured wrapper that provides a mini runtime environment for the blocks 232 associated with the service. The base service class 202 is a generic wrapper that can be configured to provide the mini runtime environment for a particular set of blocks 232. The base block class 406 provides a generic component designed to operate within the mini runtime environment provided by a service 230. A block 232 is a component that is designed to run within the mini runtime environment provided by a service 230, and generally has been extended from the base block class 406 to contain task specific functionality that is available when the block 232 is running within the mini runtime environment. The purpose of the core 228 is to launch and facilitate the mini runtime environments.

To be clear, these are the same services 230, blocks 232, base service class 202, base block class 406, and core 228 that have been described previously in detail. However, this perspective focuses on the task specific functionality that is to be delivered, and views the NIO platform 1202 as the architecture that defines how that task specific functionality is organized, managed, and run. Accordingly, the NIO platform 1202 provides the ability to take task specific functionality and run that task specific functionality in one or more mini runtime environments. Multiple NIO platforms 1202 can be combined into a distributed system of mini runtime environments.

Referring to FIG. 13, a diagram 1300 illustrates one embodiment of a hierarchical flow that begins with task specific functionality 1302 and ends with NIO platform instances 402. More specifically, the task specific functionality 1302 is encapsulated within blocks 232, and those blocks may be divided into groups (not shown). Each group of blocks is wrapped in a service 230. Each service 230 is configured to run its blocks 232 within the framework (e.g., the mini runtime environment) provided by the service 230. The configuration of a service may be used to control some aspects of that particular service's mini runtime environment. This means that even though the basic mini runtime environment is the same across all the services 230, various differences may still exist (e.g., the identification of the particular blocks 232 to be run by the service 230, the order of execution of those blocks 232, and/or whether the blocks 232 are to be executed synchronously or asynchronously).

Accordingly, the basic mini runtime environment provided by the base service class 202 ensures that any block 232 that is based on the base block class 406 will operate within a service 230 in a known manner, and the configuration information for the particular service enables the service to run a particular set of blocks. The services 230 can be started and stopped by the core 228 of the NIO platform 402 that is configured to run that service.

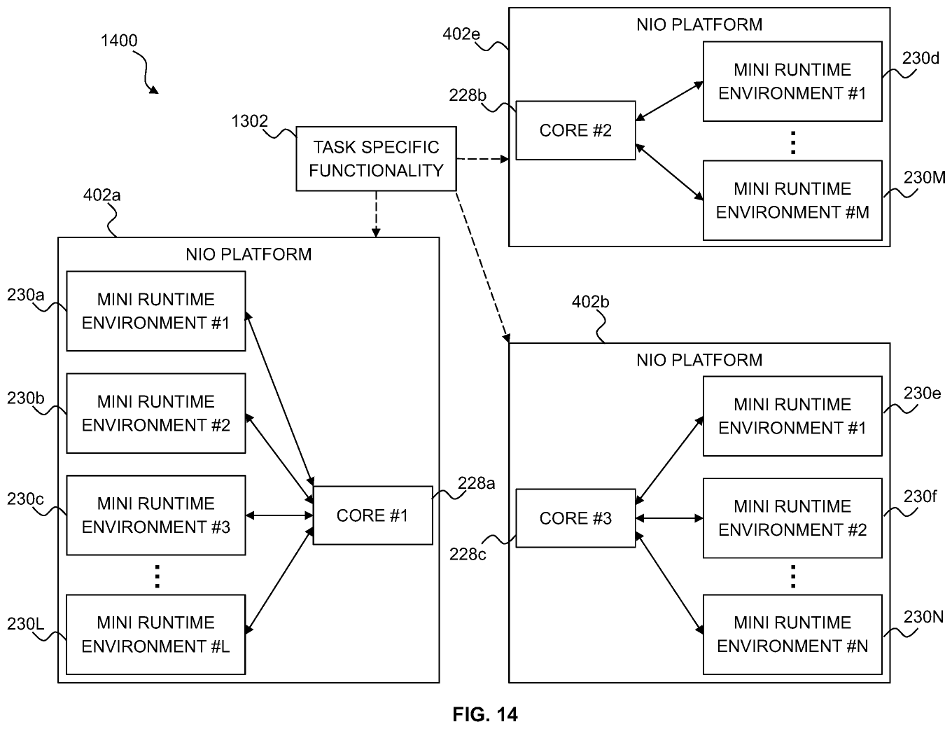

Referring to FIG. 14, one embodiment of a system 1400 is illustrated with the task specific functionality 1302 of FIG. 13. As described with respect to FIGS. 5-21, the flexibility provided by the use of blocks 232 and services 230 enables task specific functionality to be added, removed, modified, and/or distributed across a system containing multiple NIO platform instances in many different ways without requiring major modifications to the system architecture. This is further illustrated in FIG. 14 with NIO platforms 402a, 402b, and 402e, which may correspond, for example, to identically labeled platforms in FIGS. 8A-8C.

Each NIO platform 402a, 402b, and 402e can support multiple mini runtime environments (i.e., services) within which the task specific functionality 1302 can be executed. For example, the NIO platform 402a includes a core 228a (core #1) and multiple mini runtime environments 230a-230L. The NIO platform 402b includes a core 228b (core #2) and multiple mini runtime environments 230d-230M. The NIO platform 402c includes a core 228c (core #3) and multiple mini runtime environments 230e-230N. The task specific functionality 1302 can be located in some or all of the mini runtime environments, with each mini runtime environment being stopped and started as needed by the respective cores.

Accordingly, to develop a distributed system, various device/network capabilities (e.g., processor speed, memory, communication protocols, and/or bandwidth) may be identified (for an existing system) or specified (for a new system or a system being modified). The desired task specific functionality 1302 can then be distributed using a block/service distribution that accounts for those capabilities. Because of the NIO platform's architecture and the way it is able to run asynchronous and independent blocks in any mini runtime environment, the functionality can be divided in many different ways without requiring any substantial system changes as long as the device on which a particular block/service is to be run meets any requirements.

For example, in one system, edge devices may be sufficiently powerful to process relatively large amounts of data, thereby reducing network traffic. In another system, edge devices may not be so powerful and will have to transfer more data to NIO platforms on other devices for processing, thereby increasing network traffic. Because of the flexibility provided by the NIO platforms, this balancing of tradeoffs may be accomplished by distributing the same task specific functionality in different ways for each system.

For example, moving a block from a service on one device to a service on another device may be as simple as modifying the core and service configurations on both NIO platforms, updating the block's configuration (if needed), storing the block on the second NIO platform (if not already there), and updating existing input/output blocks or adding additional input/output blocks to the services (if needed) to move data from one service to another. Additionally, if a device running a NIO platform instance is powerful enough, additional services can be run by the existing NIO platform instance and/or another NIO platform instance with overlapping or totally different functionality can be started on the same device.

Accordingly, the use of distributed NIO platforms enables the design and implementation of systems where functionality, including real time processing functionality, can be shifted between NIO platforms as desired. Although some system limitations may not be addressed by moving functionality from one NIO platform to another (e.g., an edge device may not have the processing speed needed to process enough data to reduce network load as desired on a slow network), such flexibility can be advantageous when planning a system and/or modifying/upgrading an existing system. The use of NIO platforms provides a flexible distributed solution that does not lock a user into a particular configuration, but rather allows changes to be made on a per block or per service basis at any time and allows functionality to be added or removed, or simply stopped and started, as desired.

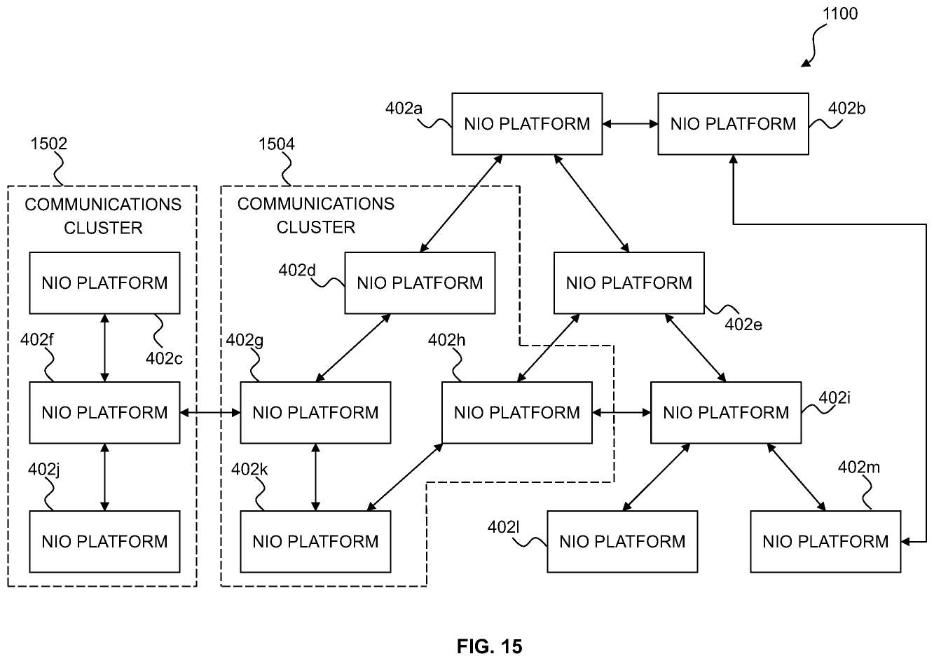

Referring to FIG. 15, another embodiment of the system 1100 of FIG. 11 illustrates how various NIO platforms 402a-402m may be grouped for communication purposes. The types of input(s) and output(s) for a specific NIO platform 402a-402m can be configured by modifying the services and their blocks as needed. It is understood that such configurations may include the use of modules and/or core components described with respect to FIGS. 9A and 9B of previously referenced U.S. patent application Ser. No. 14/885,629.

The ability to configure communication capabilities for a NIO platform at the service level provides flexibility by enabling the selection of communication types within a single NIO platform (e.g., between services), between two or more NIO platforms, and between a NIO platform and non-NIO enabled devices and software. Such selections may be used to account for particular network configurations, software and hardware requirements, protocol requirements, a particular distribution of services within a NIO platform and/or across multiple NIO platforms, and similar issues without requiring that the underlying NIO platform be changed. For example, the input and/or output communications for a particular service may be configured to use a publication/subscription model, a direct model (e.g., a TCP/IP connection), and/or another communication model as needed, and the input(s)/output(s) can use the same or different communication models. It is understood that a communication model may use one or more different communication protocols, standards, specifications, and/or implementations, and the particular model used may vary depending on the defined communication needs of a NIO platform or a group of NIO platforms.

In the present example, the options for communications between NIO platforms vary based on whether the particular NIO platforms 402a-402m are in a communications cluster. More specifically, the system 1100 includes a communication cluster 1502 and a communications cluster 1504. Communications among the NIO platforms within a communications cluster may be handled by a single communications broker using a publication/subscription model. Any NIO platform that is configured to use the broker and is able to do so (e.g., is on a device that has the correct permissions for the network) is part of the communications cluster and can publish and subscribe to channels within that communications cluster. Any NIO platforms that are not configured to use that broker or are unable to do so are outside of the communications cluster and cannot publish and subscribe to those channels.

While a communications cluster can extend over multiple networks (e.g., may simultaneously include both LAN and cloud based NIO platforms), it is often located on a single network. The broker is typically located on one of the NIO platforms within the communications cluster, but may be located elsewhere (e.g., on a server) in other embodiments. It is noted that communications between NIO platforms within a communications cluster may use other communication models in addition to, or as an alternative to, the publication/subscription model.

Accordingly, the NIO platforms 402c, 402f, and 402j are configured to use the same broker within the communications cluster 1502. The NIO platforms 402d, 402g, 402h, and 402k are configured to use the same broker within the communications cluster 1504. The remaining NIO platforms 402a, 402b, 402e, 402i, 4021, and 402m are not part of a communications cluster.

Although not shown, it is understood that each NIO platform within a communications cluster can generally communicate with any other NIO platform within the same communications cluster (e.g., via pub/sub channels managed by the communications cluster's broker). Accordingly, in addition to the connections shown between the NIO platforms 402c and 402f and the NIO platforms 402f and 402j in the communications cluster 1502, the NIO platforms 402c and 402j may also communicate directly. Similarly, each of the NIO platforms in the communications cluster 1504 may communicate directly with the other NIO platforms in the communications cluster 1504. It is understood that, in some embodiments, authentication requirements, whitelist verification, and/or other security processes may need to be satisfied before such communications occur even in the same communications cluster.

Communications can occur between NIO platforms in different communication clusters, as illustrated by the line between the NIO platform 402f of the communications cluster 1502 and the NIO platform 402g of the communications cluster 1504. Such communications may be based on TCP/IP, UDP, or another suitable communication protocol. Communications can also occur between a NIO platform within a communication cluster and a NIO platform outside of a communication cluster. This is illustrated by the line between the NIO platform 402d of the communications cluster 1504 and the NIO platform 402a that is not in a communications cluster 1504, and by the lines between the NIO platform 402h of the communications cluster 1504 and the NIO platforms 402e and 402i that are not in a communications cluster 1504. Such communications may be based on TCP/IP, UDP, or another suitable communication protocol.

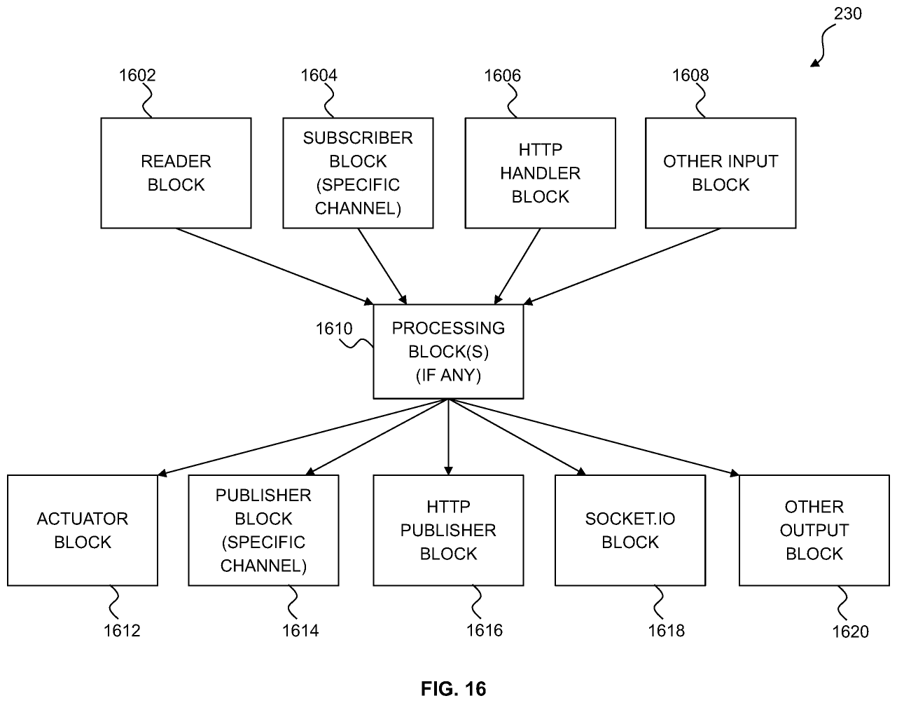

Referring to FIG. 16, one embodiment of a service 230 is illustrated with various blocks 1602-1620 that may be used to provide input and output functionality to the service 230. It is understood that not all services may be configured with input and output blocks as shown, and that some services may have input and/or output blocks located at positions within the service (e.g., not as the first or last block to be executed). However, the service 230 of the present example provides an illustration of the different ways in which a service may receive input from one or more sources and send output to one or more destinations, regardless of where the particular blocks are located in the service.

The service 230 may be configured with one or more input blocks, such as a reader block 1602 to receive data from an analog or digital device (e.g., by polling a pin or a port), a subscriber block 1604 that is configured to receive data from a particular publication channel, an HTTP handler block 1606 to receive HTTP formatted data via a TCP/IP connection, and an “other input” block 1608 that may receive data via any type of communications channel for which the block is configured. The input is passed to one or more processing blocks 1610 if such blocks are present and the service 230 is configured to do so.

The service 230 may be configured with one or more output blocks, such as an actuator block 1612 to perform an actuation, a publisher block 1614 that is configured to send data to a particular publication channel, an HTTP publisher block 1616 to send HTTP formatted data via a TCP/IP connection, a socket.io block 1618 that is configured to send data directly to a socket server, and an “other output” block 1620 that may send data via any type of communications channel for which the block is configured.

The “other” input block 1608 and “other” output block 1620 may be customized for use with any desired communication protocol, standard, specification, and/or implementation. For example, one or both of the blocks may be configured for communications based on Global System for Mobile Communications (GSM), Enhanced Data rates for GSM Evolution (EDGE), Universal Mobile Telecommunications System (UMTS), High Speed Packet Access (HSPA), Long-Term Evolution (i.e., 4G LTE), Bluetooth, Wi-Fi, RuBee, Z-Wave, near field communication (NFC), iBeacon, Eddystone, radio frequency identification (RFID), open systems interconnection (OSI), secure socket layer (SSL), point to point protocol (PPP), IPv6 over Low power Wireless Personal Area Networks (6LoWPAN), IEEE 802.11, IEEE 802.15.4, and implementations based on such standards, such as Thread and Zigbee.

It is understood that each particular customization of an input block or an output block may be directed to one or more such protocols, standards, specifications, and/or implementations, and may include configuration options that are used to configure the block for use with a particular service on a particular NIO platform. For example, the blocks 1604 and 1614 include a configurable parameter for the channel to which the block 1604 is to publish and the channel to which the block 1614 is to subscribe. The same base publisher and subscriber blocks can then be used by different services with the configurable parameters differing based on the channel to be used by the corresponding service. In another example, the block 1618 contains the task specific functionality to send content to a socket.io server room. To accomplish this, the block 1618 includes configurable parameters for a host (e.g., a location of a socket.io server), a port (e.g., a port of the socket.io server), a room (e.g., a room on the socket.io to which the content should be sent), and an option to configure the block 1618 to listen for messages from the socket.io room.

In other embodiments, an input block or an output block may not handle such protocols, standards, specifications, and/or implementations directly. In such embodiments, the block may communicate with the operating system and/or device on which the NIO platform is running, and the operating system or device may then handle the actual formatting of the data as required by the particular protocol, standard, specification, and/or implementation.

It is further understood that the ease with which changes to communications can be made depends somewhat on the design of the input blocks 1602-1608, the output blocks 1612-1620, and the processing blocks 1610. For example, if the processing block 1610 that receives the input from one of the input blocks 1602-1608 is able to handle input from any of the input blocks, then modifying the service 230 to receive a different type of input may be accomplished by simply replacing the current input block with a different input block. This scenario may occur, for example, if the task specific functionality of the input blocks 1602-1608 is customized to produce a similar or identical output, or the task specific functionality of the processing block 1610 is customized to handle different types of information to account for differences between the input blocks 1602-1608. However, if the processing block 1610 is only able to receive input from a particular one of the input blocks 1602-1608 (e.g., the input is in a format produced by the particular output block but other output blocks use different formats), then the processing block 1610 may also need to be replaced or modified for compatibility if the input block is changed.

The same issue exists with the processing blocks 1610 and the output blocks 1612-1620, with the ease of change depending on how the processing block 1610 formats and presents information to the output blocks 1612-1620 and how the output blocks 1612-1620 handle the information received from the processing block 1610. In the present example, the input blocks 1602-1608 and output blocks 1612-1620 are designed to be swappable without requiring any changes to the processing blocks 1610. In other embodiments, one or more of the processing blocks 1610 may require changes when one of the input blocks 1602-1608 or output blocks 1612-1620 is changed.

Accordingly, the service 230 can be configured to receive and send data as desired by selecting and configuring the appropriate input and output blocks for the service 230 to use. Multiple input blocks and output blocks can be used to configure the service 230 with alternate or additional receive and send functionality. This means that a single service 230 can handle multiple types of inputs and outputs, either simultaneously or as alternatives based on defined criteria, which provides a great deal of flexibility. As each service 230 on a NIO platform can be configured individually, the communications capability of the NIO platform can be modified simply by adding, removing, and/or changing the input and/or output blocks used by a service. This flexibility is extremely useful when the NIO platform is being configured for use as part of a tiered structure of NIO platforms, as the services can be configured for whatever communications are desired simply by configuring each service to use the desired input and output blocks.

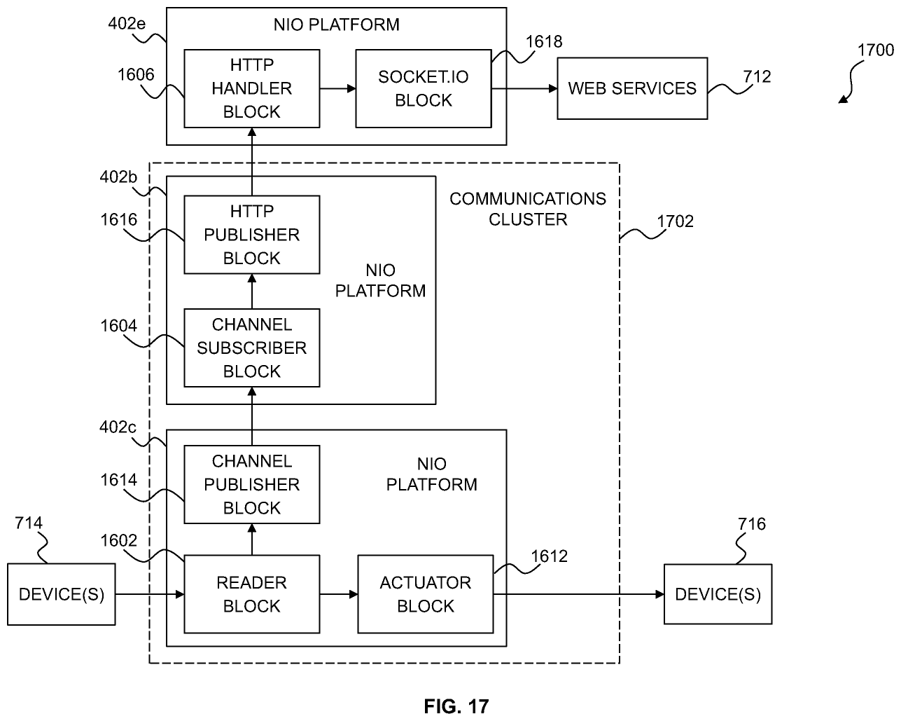

Referring to FIG. 17, one embodiment of a system 1700 is illustrated with the NIO platforms 402b, 402c, and 402e, and the devices 714 and 716 of FIG. 7. In the present example, the NIO platform 402c receives input from the device 714 and actuates the device 716. It is understood that the devices 714 and 716 may be the same device in some embodiments. The NIO platforms 402b and 402c are in a communications cluster 1702, and the NIO platform 402e is not in the communications cluster 1702.

The system 1700 is illustrated with only input and output blocks present for each NIO platform 402b, 402c, and 402e in order to illustrate how the NIO platforms may communicate. The services and other processing blocks are omitted, as are any intra-platform input and output blocks that may be used between services on a single NIO platform.

The NIO platform 402c receives input from the device 714 using a reader block 1602. The NIO platform 402c sends output as an actuation to device 716 using an actuator block 1612 and as a publication to a specific channel using channel publisher block 1614. The outputs may be sent by a single service or by different services. If different services are used, the inter-service communications may be accomplished via a publication/subscription model or in a different way.

The NIO platform 402b receives input from the NIO platform 402c using a channel subscriber block 1604, and sends HTTP compliant output to the NIO platform 402e using an HTTP publisher block 1616. The NIO platform 402e receives input from the NIO platform 402b using an HTTP handler block 1606, and sends an output to the web services 712 using a socket.io block 1618.

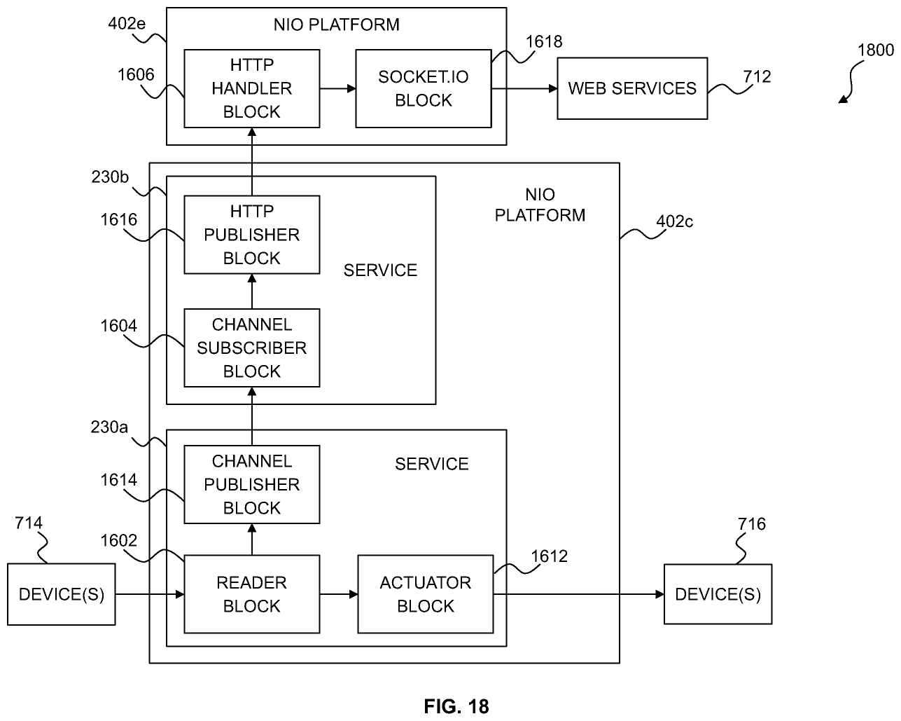

Referring to FIG. 18, one embodiment of a system 1800 is illustrated with the NIO platforms 402c and 402e and the devices 714 and 716 of FIG. 17. In the present example, the NIO platform 402c includes services 230a and 230b that provide the functionality that was previously divided between the NIO platforms 402b and 402c in FIG. 17. The channel publisher block 1614 and channel subscriber block 1604 are now used to route information from the service 230a to the service 230b on the single NIO platform 402c, rather than between two different NIO platforms as illustrated in FIG. 17. This illustrates the ease with which services can be distributed or consolidated on a per platform basis, and also illustrates the usefulness of being able to configure communications on a per service basis.

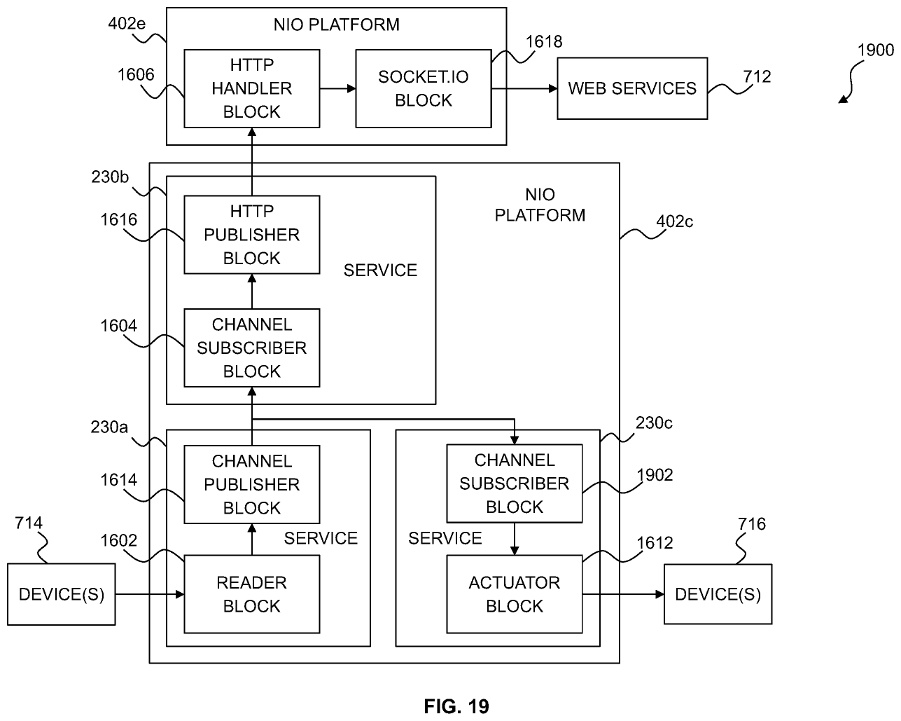

Referring to FIG. 19, one embodiment of a system 1900 is illustrated with the NIO platforms 402c and 402e and the devices 714 and 716 of FIG. 18. In the present example, the NIO platform 402c includes services 230a and 230c that provide the functionality that was previously contained in the service 230a in FIG. 18. The channel publisher block 1614 and a channel subscriber block 1902 in the service 230c are now used to route information from the service 230a to the service 230c. This illustrates the ease with which services can be distributed or consolidated on a per platform basis, and also illustrates the usefulness of being able to configure communications on a per service basis.

It is understood that the embodiments of FIGS. 17-19 may be provided using multiple NIO platform instances running on a single device as shown in FIG. 11 of previously referenced U.S. patent application Ser. No. 14/885,629. Some or all of the NIO platform instances on the device may be part of a communications cluster and/or may use other communication channels to communicate with each other, to communicate with NIO platforms external to the device, and to communicate with devices that do not use NIO platforms. For example, the services 230a-230c of FIG. 19 may be run by separate NIO platform instances, rather than the single NIO platform instance 402c, and those NIO platform instances may be running on a single device. In some embodiments, the NIO platform 402e may also be running on the same device as the other NIO platforms. In some embodiments, different NIO instances on the same device may be part of different communications clusters.

Accordingly, the various communication channels described herein may be used within a single NIO platform instance, between NIO platform instances on a single device, and between NIO platform instances on different devices. In addition, a NIO platform instance may use one or more of the communication channels described herein to communicate with the device or a part of the device (e.g., a sensor) on which the NIO platform instance is running, in addition to or as an alternative to communicating with an operating system and/or any APIs running on the device using defined OS and API calls.

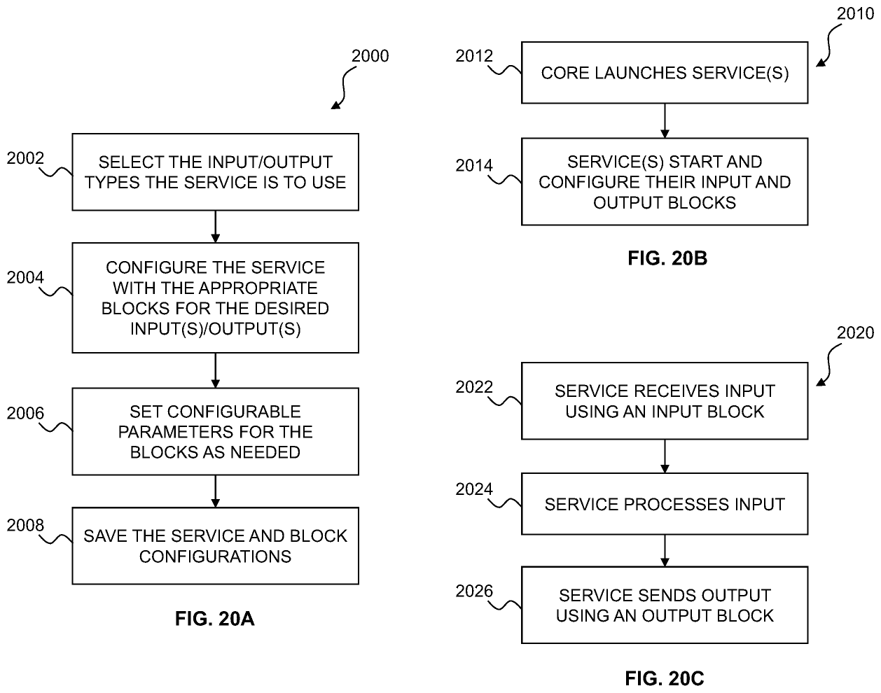

Referring to FIG. 20A, a method 2000 illustrates one embodiment of a process that may be executed to configure a service (e.g., the service 230 of FIG. 16) of a NIO platform for communication. As previously described, various blocks may contain task specific instructions for providing particular types of communications. Such blocks may include configurable parameters that can be used to configure a block for use by the particular service 230.

In step 2002, the input(s) and output(s) that the service 230 will be using are selected. As illustrated in previous examples, this may depend on the other services and/or devices with which the service 230 will be communicating, whether the NIO platform running the service 230 is within a communications cluster, and similar factors. In step 2004, the service 230 is configured with the appropriate blocks for the desired input(s) and output(s). In step 2006, configurable parameters within the blocks may be set as needed. In step 2008, the service and block configurations are saved for use by the NIO platform.

Referring to FIG. 20B, a method 2010 illustrates one embodiment of a process that may be executed by a NIO platform. In step 2012, the NIO platform's core launches the services as previously described. In step 2014, the services start and configure their input and output blocks for use in communications.

Referring to FIG. 20C, a method 2020 illustrates one embodiment of a process that may be executed by a running service (e.g., the service 230 of FIG. 16). As previously described, various blocks may contain task specific instructions for providing particular types of communications. In step 2022, the service 230 receives input using an input block, which handles the input as configured. In step 2024, the service 230 processes the input. In step 2026, the service 230 produces output using an output block, which handles the output as configured. As described previously, the task specific functionality of the input and output blocks and their configurations may be modified to alter the input and output functionality of the service 230.

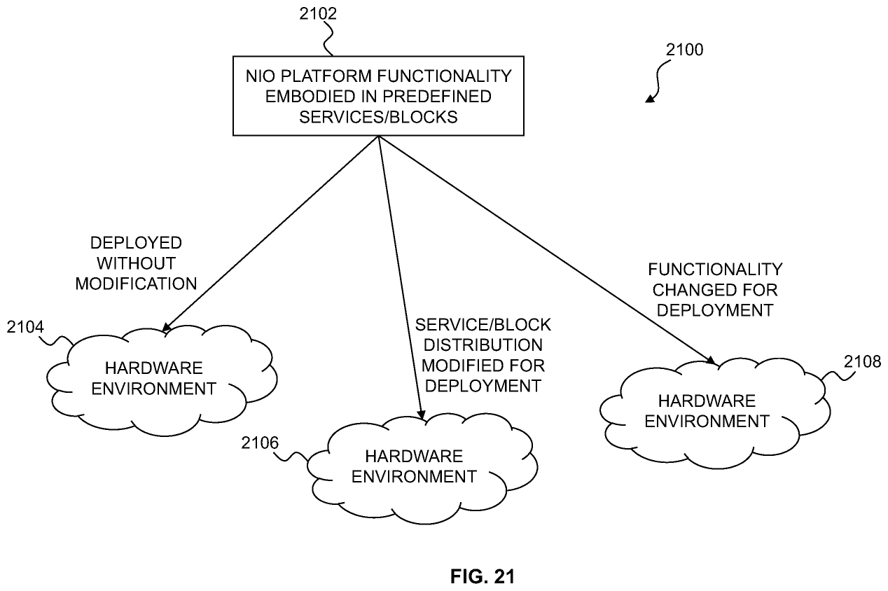

Referring to FIG. 21, one embodiment of an environment 2100 illustrates task specific NIO platform functionality 2102 that is embodied in services 230 and blocks 232 (not shown). The functionality 2102 may be of any level of complexity and may range from a single service that is expected to be run on a single NIO platform to many different interrelated services that are expected to be run on one or more NIO platforms (e.g., in a distributed manner). For example, the functionality 2102 may be for a specific task (e.g., a service configured to read from a specific sensor, monitor an external device or a data stream, report on device characteristics, or publish received information to a web socket) or may be for a more complex system such as a management and control system for an industrial environment or an agricultural environment. The functionality may provide a base level of functionality (e.g., a barebones system) or may be a fully realized management system capable of monitoring, controlling, actuating, reporting, and/or performing other tasks.

As previously described, services 230 and blocks 232 can be easily distributed as desired (assuming each target device has the processing capability needed to run the specified services) and service communication capabilities can be changed as needed. Accordingly, the NIO platform architecture enables the functionality 2102 to be designed and embodied in services and blocks as a system configuration for a system that can then be deployed to different hardware environments 2104, 2106, and 2108. In some embodiments, the system configuration may also identify NIO platform instances to which the services are assigned.

Although referred to herein as hardware environments, it is understood that the hardware environments 2104, 2106, and 2108 may include software, including operating systems and/or applications, and may also be referred to as computing environments. The different hardware environments 2104, 2106, and 2108 may have different requirements and/or capabilities, and may or may not be able to run the functionality 2102 in the exact configuration embodied by the services and blocks. However, by modifying the organization and/or distribution of the services and blocks to adjust for different processing and memory resources, different levels of network availability and network protocols, and/or other factors, the predefined functionality 2102 may be deployed to the different hardware environments 2104, 2106, and 2108 with relatively little effort. It is understood that NIO platforms may be distributed as desired to run the services.

For purposes of illustration, the functionality 2102 can be deployed to the hardware environment 2104 without modification to the organization and distribution of the services and blocks. It is understood that services and blocks may still need to be configured and some blocks may need to be modified or created (e.g., to read from and/or actuate a particular device within the hardware environment 2104) as needed for the hardware environment 2104, but the overall organization and distribution of services and blocks embodying the functionality 2102 will remain the same. For example, a generic read block may be positioned as a placeholder within a service, and the generic read block may be replaced with a customized read block when the service is deployed. This does not affect the organization of the service or the location of the block within the service, and is treated as a configuration action in the present example. The hardware environment 2104 may be pre-existing, but able to handle the services as designed, or may be a new environment that was created specifically to support the functionality 2102 as embodied in the services 230.

Deploying the functionality 2102 to the hardware environment 2106 requires that the services and/or blocks be organized and/or distributed in a modified manner. For example, if some services were intended to be deployed on edge nodes, the devices running the edge nodes within the hardware environment 2106 may not be powerful enough to properly run those services. To adjust for this, some or all services may be moved away from the edge nodes to more powerful devices that are not at the edge. In another example, services originally intended to be run away from the edge may be pushed to edge nodes due to the processing needs or capabilities of the hardware environment 2106. Services may also be subdivided into multiple services or combined into larger services if needed.

Accordingly, the functionality 2102 may be deployed to the hardware environment 2106 by modifying how the services and blocks are organized and distributed without changing the functionality 2102 itself. This example may require changes to the communication blocks of one or more services, such as is described with respect to FIGS. 18 and 19 when splitting a service into multiple services and adding additional channel publisher and channel subscriber blocks. Another example would be if a service is moved outside of a communications cluster and a channel publisher block in the service is changed to another communications block such as an HTTP publisher block.

Deploying the functionality to the hardware environment 2108 requires changes to the functionality 2102. For example, the hardware environment 2108 may not have the processing or network capacity to support the functionality 2102 in its entirety, and various features may need to be modified or removed. In other embodiments, changes may be made for compatibility purposes. Functionality may also be added. Such modifications may or may not require changes to the organization and distribution of the remaining services and blocks.

Accordingly, the NIO platform architecture enables an entire system of services and blocks to be built and then deployed to different hardware environments in whatever way is desired or needed for each hardware environment (assuming that a particular hardware environment has the ability to support the system). This means that the services can be modified to work within a pre-existing hardware environment or a hardware environment can be created that is ideal for the system. A pre-existing hardware environment can also be upgraded if needed to support the system of services and blocks. Services can be placed at the edge, upstream from the edge, or in the cloud depending on the needs (e.g., remote access) of the particular deployment and the resource availability of the hardware environment.

It is noted that the granularity provided by the service and block architecture enables relatively minor adjustments to be made easily and as needed. For example, if a NIO platform instance is to run services that require X computing resources (e.g., processing capability, available memory, and/or network bandwidth/availability) based on the original service organization and distribution, but is being deployed on a device that can only provide Y resources (where Y<X), then services and/or blocks can be offloaded to other devices as desired to reduce the resource usage to Y or fewer resources. This reduction can be accomplished in many different ways and may include moving one or more entire services or only parts of one or more services. For example, a single service that uses a large percentage of the resources may be moved or multiple smaller services may be moved. This flexibility in tailoring the location of the functionality enables an optimal organization and distribution of service and blocks to be selected for each part of the hardware environment while minimizing or eliminating changes to the organization and distribution of the remaining services and blocks.

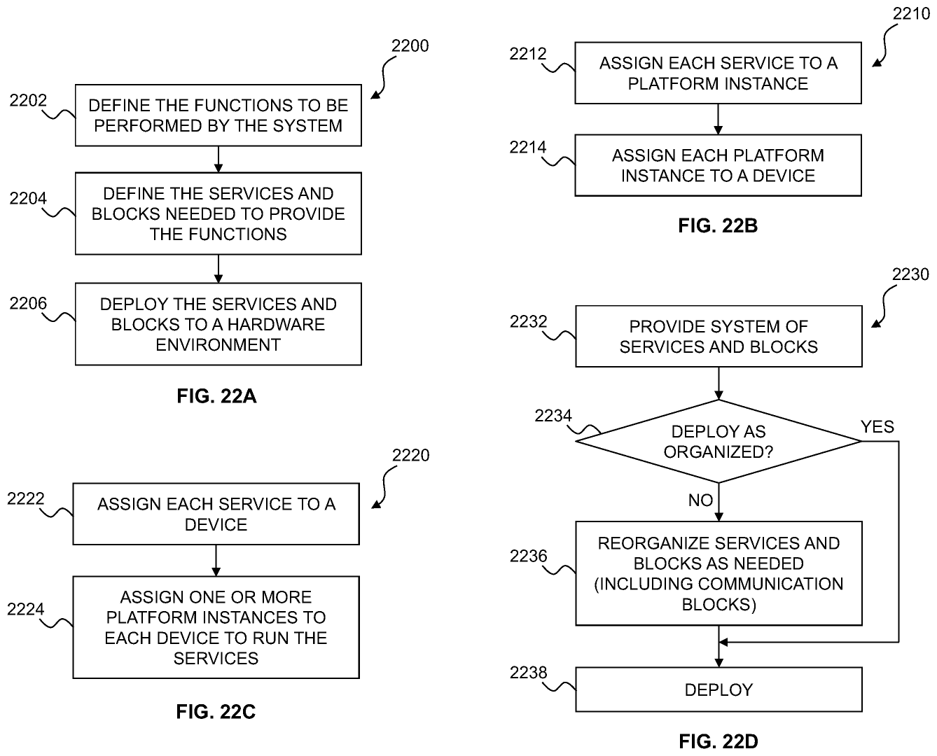

Referring to FIG. 22A, a method 2200 illustrates one embodiment of a process that may be used to create and deploy a system of services and blocks as described with respect to FIG. 21. In step 2202, the functionality of the system is defined. In step 2204, one or more services and blocks are defined to embody the functionality. As described previously, the system may be defined in many different ways and there is likely no single organization of services and blocks that is ideal for all hardware environments. Accordingly, many different combinations of services and blocks may be created to embody the functionality. In some embodiments, a target hardware environment may be used to provide structure in planning how the services and blocks are to be organized and distributed.

Furthermore, various methodologies may be adopted and applied, such as attempting to push functionality to the edge wherever possible in low bandwidth hardware environments or ensuring that there is a cloud node for data storage and remote visualization. Accordingly, various principles may be used to guide the organization of the services and blocks in step 2204 and such principles may vary depending on the hardware environment within which the system is intended to be deployed. For example, a system intended for deployment to a mobile device may have a different set of design principles than a system intended for deployment to a manufacturing or agricultural environment that uses a network of distributed devices.

In step 2206, the services and blocks are deployed. The deployment may use the original organization or may require modifications as described with respect to FIG. 21. The actual deployment process may vary depending on the hardware environment to which the system is being deployed and whether the hardware environment supports the originally designed organization and distribution of the services and blocks. Various examples are described with respect to FIGS. 22B-22D.

For example, referring to FIG. 22B, a method 2210 illustrates one embodiment of a process in which each service may be assigned to a platform instance in step 2212 and each platform instance may be assigned to a device within the hardware environment in step 2214. In another example, as shown in FIG. 22C, a method 2220 illustrates one embodiment of a process in which each service may be assigned to a device in step 2222 and one or more platform instances may then be assigned to each device to run the services in step 2224.

Referring to FIG. 22D, a method 2230 illustrates one embodiment of a process in which a system of services and blocks are provided in step 2232. In step 2234, a determination may be made as to whether the system should be deployed as currently organized. If the system is to be deployed as currently organized, the method 2230 moves to step 2238, where the system is deployed. If the system is not to be deployed as currently organized, the method 2230 moves to step 2236. This may occur, for example, if a review of the hardware environment indicates that the system cannot be deployed in its current state. In step 2236, the services and blocks are reorganized as needed, which may include modifying communication blocks. The method 2230 then moves to step 2238 and the system is deployed in its reorganized state.

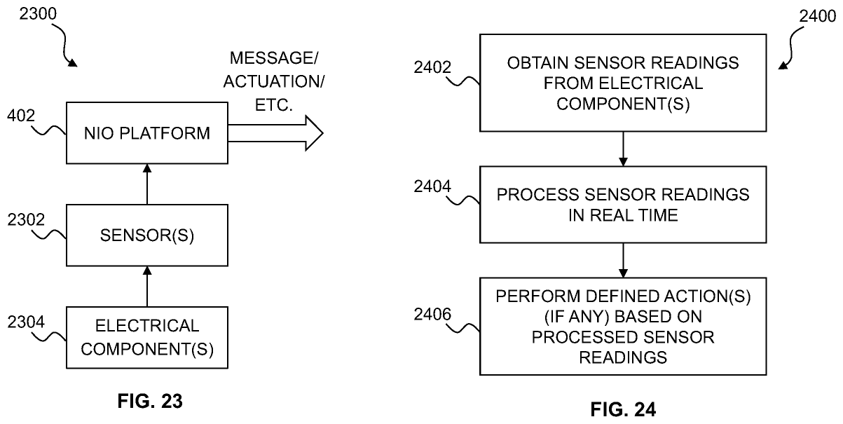

Referring to FIG. 23, one embodiment of an environment 2300 illustrates the NIO platform 402 of FIG. 4A, one or more sensors 2302, and one or more electrical components 2304. As will be described below in greater detail, the NIO platform 402 is configured to receive inputs from the sensor 2302 that is coupled to the electrical component 2304.

The electrical component 2304 may be any active, passive, or electromechanical discrete device or physical entity that uses, transfers, communicates with, and/or produces electricity in any form, and may be standalone or part of a larger device. Active components include semiconductors (e.g., diodes, transistors, integrated circuits, and optoelectronic devices), display technologies, vacuum tubes, discharge devices, and power sources. Passive components include resistors, capacitors, magnetic (inductive) devices, memristors, networks, transducers, sensors, detectors, antennas, assemblies, modules, and prototyping aids. Electromechanical components include piezoelectric devices (including crystals and resonators), terminals and connectors, cable assemblies, switches, protection devices, and mechanical accessories (e.g., heat sinks and fans). The sensor 2302 is any type of sensor that is capable of sensing the desired characteristic(s) of the electrical component 2304 and producing a signal representing the characteristic(s).

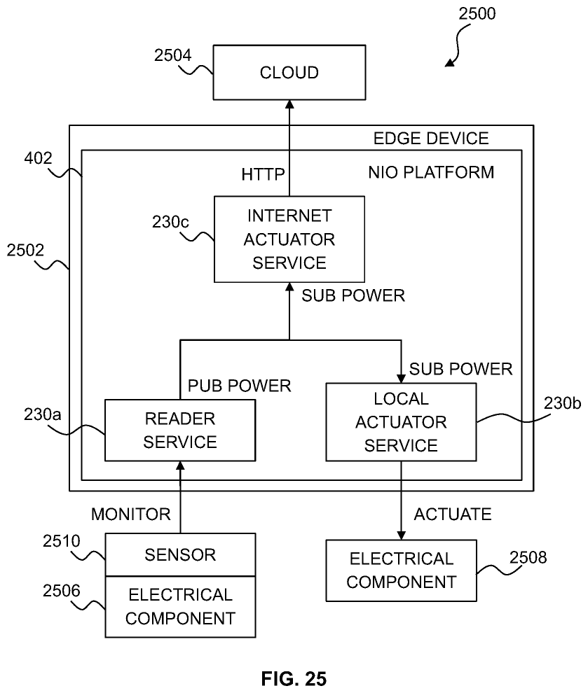

The NIO platform 402 processes the inputs from the sensor 2302 based on the platform's configuration and produces one or more outputs, which may include messages and/or actuations. The functionality of the NIO platform 402 may be provided on a single platform (as will be described below with respect to FIG. 25) or may be distributed across multiple platforms (as will be described below with respect to FIG. 30).

Referring to FIG. 24, a method 2400 illustrates one embodiment of a process that may be executed by the NIO platform 402 of FIG. 23. Alternatively, the method 2400 may be executed by multiple NIO platforms if the functionality has been distributed. In step 2402, the NIO platform 402 obtains sensor readings from the sensor 2302 about the electrical component 2304. In step 2404, the sensor readings are processed by the NIO platform 402 based on the particular configuration of the NIO platform. Accordingly, the NIO platform 402 will have blocks 232 (not shown) capable of receiving input from the sensor 2302 and processing that input. In step 2406, one or more defined actions may be taken based on the processed input. As described in previous embodiments, the receipt, processing, and performance of any actions may occur in real time due to the architecture of the NIO platform 402.

Referring to FIG. 25, one embodiment of a system 2500 illustrates a power monitoring and actuation system using the single NIO platform 402 of FIG. 23. The NIO platform 402 is located on an edge device 2502 and also has a communication link that enables the NIO platform 402 to communicate with the cloud 2504. The NIO platform 402 is coupled to an electrical component 2506 and an electrical component 2508. The electrical components 2506 and 2508 may be separate components (as shown) or may represent a single component.

For purposes of example, the NIO platform 402 is shown with a configuration of specific services for implementing the functions illustrated with respect to the method 2400 of FIG. 24. A reader service 230a receives input from the electrical component 2506 via a sensor 2510 and publishes to a channel named “Power.” A local actuator service 230b subscribes to the Power channel to receive input from the reader service 230a. The local actuator service 230b then controls the actuation of the electrical component 2508 based on the received input. An internet actuator service 230c subscribes to the Power channel, and formats and sends information to the cloud 2504 based on the input.

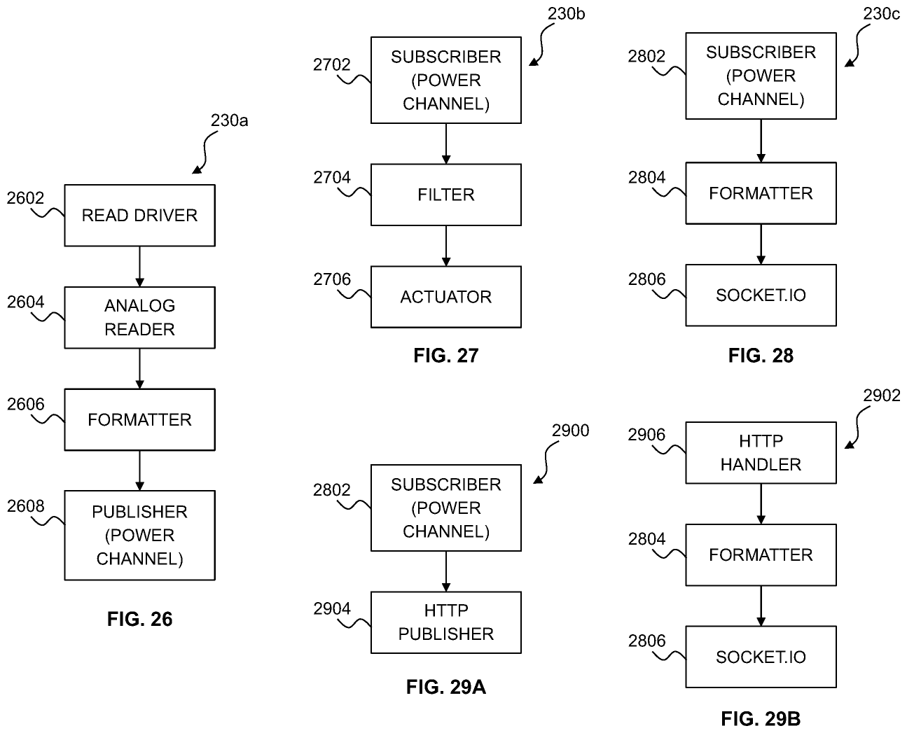

Referring to FIG. 26, one embodiment of the reader service 230a of FIG. 25 is illustrated. In the present example, the reader service 230a includes multiple blocks, including a read driver block 2602, an analog reader block 2604, a formatter block 2606, and a publisher block 2608.

The read driver block 2602, which may be omitted in some embodiments, is a simulator block that drives how frequently the sensor 2510 should be read. For example, the read driver block 2602 may have a parameter that can be set with a time (e.g., 0.1, 0.5, or one second) to trigger a sensor read. The output from the read driver block 2602 is directed to the analog reader block 2604 to trigger the actual read action. The analog reader block 2604 reads one or more values from the sensor 2510 coupled to the electrical component 2506 each time the analog reader block 2604 receives a trigger from the read driver block 2602. The output from the analog reader block 2604 is directed to the formatter block 2606. The formatter block 2606 formats the sensor data obtained by the analog reader block 2604 for use by other services if needed. The output from the formatter block 2606 is directed to the publisher block 2608. The publisher block 2608 publishes the data to the “Power” channel.

Referring to FIG. 27, one embodiment of the local actuator service 230b of FIG. 25 is illustrated. In the present example, the local actuator service 230b includes multiple blocks, including a subscriber block 2702, a filter block 2704, and an actuator block 2706.

The subscriber block 2702 subscribes to the Power channel to receive information from the reader service 230a. The output from the subscriber block 2702 is directed to the filter block 2704. The filter block 2704 determines whether or not an actuation of the electrical component 2508 should be performed based on the received information. It is understood that the logic executed by the filter block 2704 may be more complex than a simple filter and, in some embodiments, may be provided by another service or services. By positioning the actuation logic of the filter block 2704 on the edge device 2502, edge filtering is provided that minimizes the amount of noise transmitted across a network. This edge filtering also minimizes response time as there is no need to account for any network round trip transmission time that might delay an actuation. The output from the filter block 2704 is directed to the actuator block 2706. The actuator block 2706 performs any needed actuation of the electrical component 2508.

Referring to FIG. 28, one embodiment of the internet actuator service 230c of FIG. 25 is illustrated. In the present example, the internet actuator service 230c includes multiple blocks, including a subscriber block 2802, a formatter block 2804, and a socket.io block 2806.

The subscriber block 2802 subscribes to the Power channel to receive information from the reader service 230a and may be the same basic block as the subscriber block 2702 of the local actuator service 230b. The output from the subscriber block 2802 is directed to the formatter block 2804. The formatter block 2804 may handle formatting of the information as needed. For example, if the information is to be visualized, the formatter block 2804 would handle the formatting needed for visualization. The output from the formatter block 2804 is directed to the socket.io block 2806. The socket.io block 2806 sends the information to a socket.io server (not shown) so that the information can be visualized on a web page. For example, the socket.io block 2806 may send the information directly to the web services 712 of FIG. 7, which may be running on a socket.io server in the cloud.

Referring to FIG. 30, one embodiment of a system 3000 illustrates a power monitoring and actuation system using multiple NIO platforms 402a-402d. The functionality described with respect to the services 230a-230c of FIG. 25 are distributed among the NIO platforms 402a-402d, rather than being located on a single NIO platform as described with respect to FIG. 25. It is understood that the functionality may be distributed in many different ways, and the current embodiment is only one possible distribution.

The NIO platforms 402a-402d are positioned in a tiered arrangement. More specifically, the NIO platform 402a is located on an edge device 3002 and is coupled to an electrical component 3012 via a sensor 3016. The NIO platform 402b is located on an edge device 3004 and is coupled to an electrical component 3014. The electrical components 3012 and 3014 may be separate components (as shown) or may represent a single component. The NIO platform 402c is located on a non-edge device 3006 and has a communication link that enables the NIO platform 402c to communicate with the NIO platform 402d located in the cloud 3008.

For purposes of example, the NIO platform 402a is configured with the reader service 230a of FIGS. 25 and 26 to read the sensor 3016. The NIO platform 402b is configured with the local actuator service 230b of FIGS. 25 and 27 to handle the actuation of the electrical component 3014. The NIO platforms 402c and 402d each handle part of the internet actuator service 230c of FIGS. 25 and 28, although this may require additional blocks as will be described below.

Communications among the NIO platforms 402a-402c are handled by a communications broker and the NIO platforms 402a-402c form a single communications cluster 3010. As described previously with respect to FIG. 15, any NIO platform that is configured to use the broker is part of the communications cluster 3010 and can publish and subscribe to channels within that cluster (e.g., the Power channel). Any NIO platforms that are not configured to use the broker are outside of the communications cluster 3010 and cannot publish and subscribe to those channels. Accordingly, the NIO platform 402d cannot subscribe to the Power channel. With respect to FIG. 30, as only the NIO platform 402c is handling non-local communications outside of the communications cluster 3010, only the NIO platform 402c needs communication access to the cloud 3008.

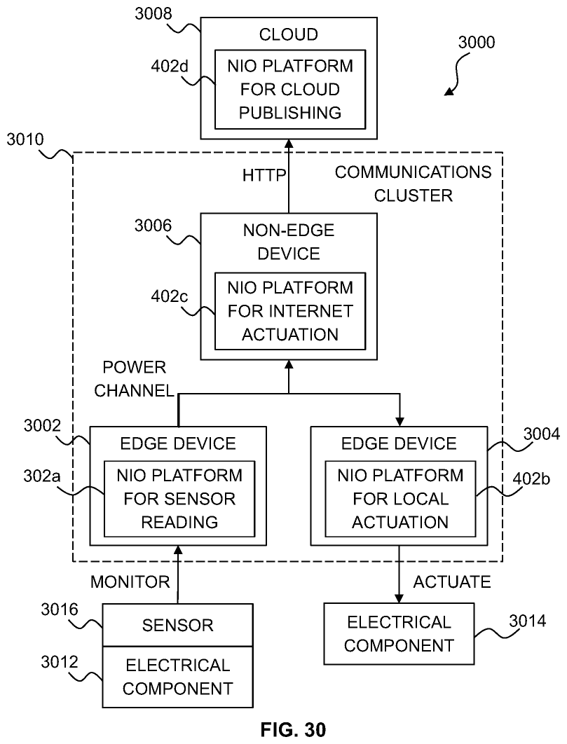

Referring to FIGS. 29A and 29B, one embodiment of the internet actuator service 230c of FIG. 25 is illustrated after being separated between the NIO platform 402c and the NIO platform 402d of FIG. 30. More specifically, the NIO platform 402c runs an internet actuator service 2900 (FIG. 29A) and the NIO platform 402d runs a cloud publishing service 2902 (FIG. 29B).

In the present example, the internet actuator service 2900 includes multiple blocks, including the subscriber block 2802 of FIG. 28 and an HTTP publisher block 2904. As described previously, the subscriber block 2802 subscribes to the Power channel to receive information from the reader service 230a. The output from the subscriber block 2802 is directed to the HTTP publisher block 2904. The HTTP publisher block 2904 is different than the publisher block 2608 and does not use the broker of the communications cluster 3010. The HTTP publisher block 2904 instead sends information out of the communications cluster 3010 via HTTP to the NIO platform 402d.

The cloud publishing service 2902 includes multiple blocks, including an HTTP handler block 2906, the formatter block 2804 of FIG. 28, and the socket.io block 2806 of FIG. 28. The HTTP handler block 2906 provides an HTTP endpoint to which the internet actuator service 2900 can send data. The output from the HTTP handler block 2906 is directed to the formatter block 2804, which operates with the socket.io block 2806 as previously described.

It is understood that the functionality may be distributed into more or fewer NIO platforms as desired. Furthermore, each NIO platform may be configured with one or more services to handle the particular functions assigned to that NIO platform. Accordingly, a great deal of flexibility is provided.

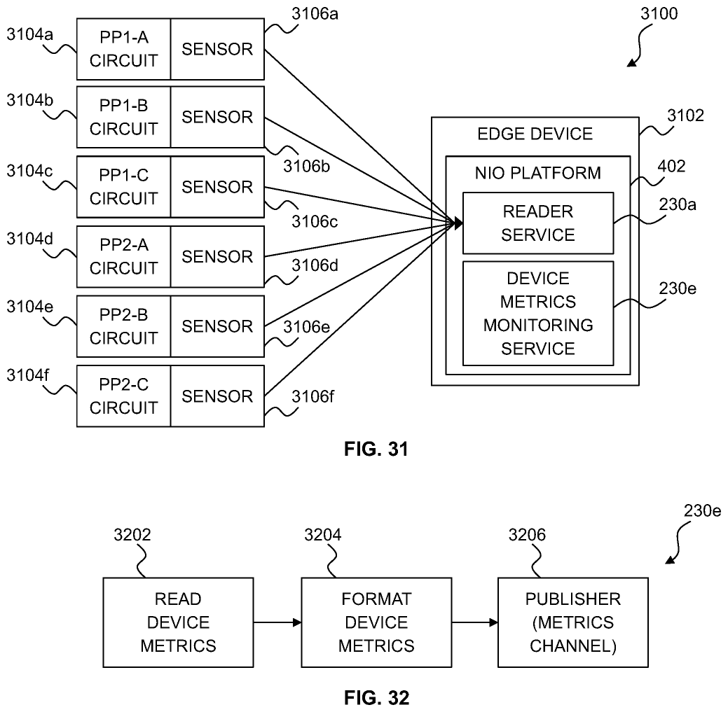

Referring to FIG. 31, another embodiment of a system 3100 illustrates a power monitoring system using a single NIO platform 402. The NIO platform 402 is located on an edge device 3102 and is running the reader service 230a of FIG. 25. The NIO platform 402 may be a standalone monitoring platform as described with respect to FIG. 25, or may be part of a tiered system as described with respect to FIG. 30. It is understood that other services (e.g., the services 230b and 230c of FIG. 25) may also be running on the NIO platform 402, but only the reader service 230a is illustrated for purposes of the present example.

The NIO platform 402 is configured to monitor multiple electrical components 3104a-3104f that form two power panels labeled “Power Panel 1” (PP1) and “Power Panel 2” (PP2), each of which has three circuits labeled A, B, and C. Accordingly, the six circuits monitored by the NIO platform are 1-A, 1-B, 1-C, 2-A, 2-B, and 2-C. Each circuit 3104a-3104f is read by a sensor 3106a-3106f, respectively. The sensors 3106a-3106f are read by, or push data to, the reader service 230a.

It is understood that the NIO platform 402 may be used to monitor the circuits 3104a-3104f even if the circuits 3104a-3104f have different configurations and/or the sensors 3106a-3106f are measuring different characteristics. In such cases, the flexibility of the NIO platform 402 may be leveraged by modifying the configuration of the service 230a and/or blocks. In some embodiments, depending on the particular circuits 3104a-3104f and/or sensors 3106a-3106f, additional services and/or blocks may be needed to configure the NIO platform 402 with the desired monitoring functionality.

With additional reference to FIG. 32, one embodiment of the device metrics monitoring service 230e of FIG. 31 is illustrated. In the present example, the device metrics monitoring service 230e includes multiple blocks, including a read device metrics block 3202, a format device metrics block 3204, and a publisher block 3206.

The read device metrics block 3202 reads information from the device 3102 at timed intervals using, for example, an I/O interface provided by the device 3102. The information may include, but is not limited to, information about socket connections, CPU percentage, swap memory, process identifiers, disk I/O statistics, network I/O statistics, disk usage, and virtual memory. The output from the read device metrics block 3202 is directed to the format device metrics block 3204. The format device metrics block 3204 formats the information obtained by the read device metrics block 3202 for use by other services if needed. The output from the format device metrics block 3204 is directed to the publisher block 3206. The publisher block 3206 publishes the data to a “Metrics” channel. This channel may then be subscribed to by another service (e.g., the internet actuator service 230b of FIG. 27 or the internet actuator service 2900 of FIG. 29A) and published.

Referring again to FIG. 31, the NIO platform 402, either itself or in conjunction with other NIO platforms, produces the information needed to provide a real time display of the current amperage of each of the circuits 3104a-3104f, as well as information on the performance of the device 3102 on which the NIO platform is running. It is understood that the actual display may be generated by a NIO platform or may use additional services, such as the web services 712 of FIG. 7.

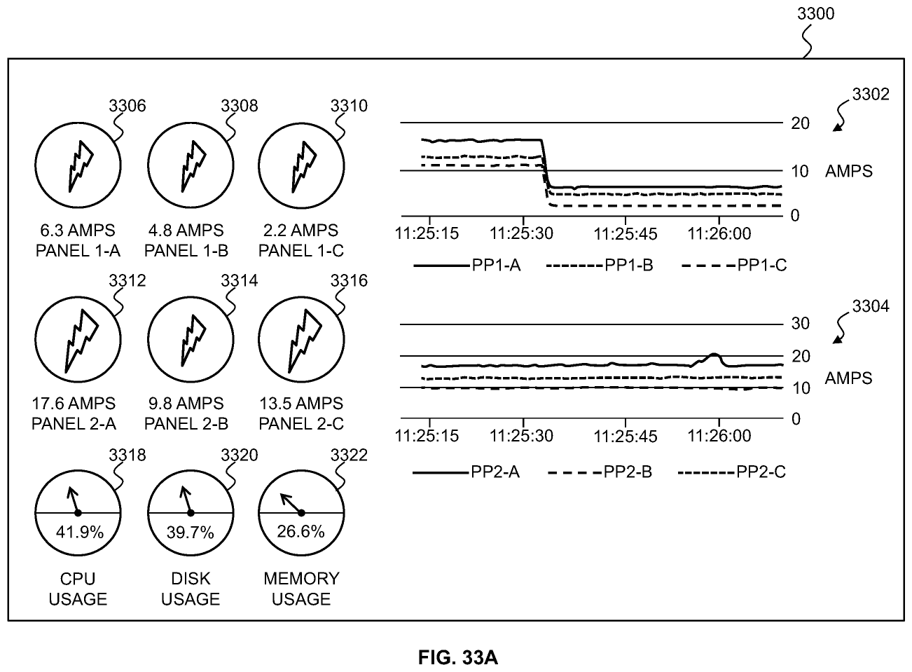

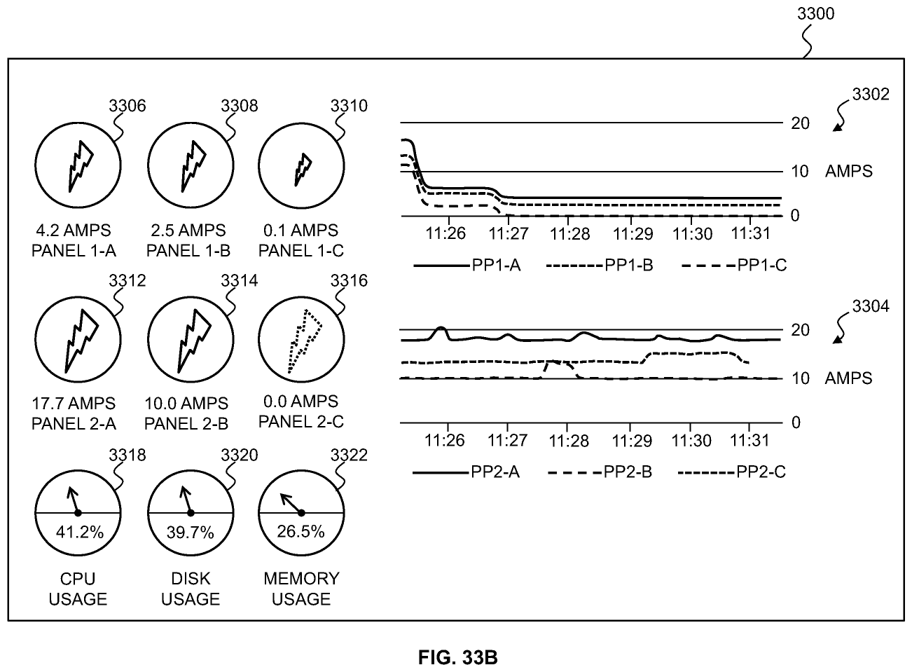

With additional reference to FIGS. 33A and 33B, one embodiment of a GUI 3300 is illustrated with real time information relating to the circuits 3104a-3104f obtained by the reader service 230a of FIG. 31. The GUI 3300 also provides real time information on the performance of the device 3102 using the device usage monitoring service 230e. It is noted that the services 230a and 230e, as well as the blocks within each service, may run asynchronously as described in previous embodiments, and therefore can update the GUI 3300 as desired without interfering with one another. Information may be obtained and streamed to the GUI 3300 by one or more NIO platforms in real time or near real time (e.g., without first being stored in a persistent memory). In addition, various aspects of the visualization, alerts, and/or actuations described herein may be set, toggled, and/or otherwise modified by configuration commands sent to the NIO platform(s).

Referring specifically to FIG. 33A, the GUI 3300 provides two graphs 3302 and 3304, each having an x-axis representing time and a y-axis representing amperage. The graph 3302 illustrates the amperage of the circuits 3104a-3104c (i.e., PP1-A, PP1-B, and PP1-C) as individual lines. The graph 3304 illustrates the amperage of the circuits 3104d-3104f (i.e., PP2-A, PP2-B, and PP2-C) as individual lines. The current amperage of each circuit 3104a-3104f is shown on the far right of each graph 3302 and 3304 with historical data moving to the left. It is noted that the historical data is maintained in the present example by the web services and not by a NIO platform, although a NIO platform may store the historical data if configured to do so.

The current amperage for the circuits 3104a-3104f is also shown by indicators 3306-3316, respectively, and the text accompanying each indicator. For example, indicator 3306 corresponds to Panel 1-A (circuit 3104a) and indicates that the current amperage value is 6.3 amps. This corresponds to the line for PP1-A at the far right on graph 3302. Similarly, indicator 3316 corresponds to Panel 2-C (circuit 31040 and indicates that the current amperage value is 13.5 amps. This corresponds to the line for PP2-C at the far right on graph 3302. As the graphs 3302 and 3304 illustrate the current amperage in real time, the previously graphed information will shift to the left and may eventually disappear if the graph does not scale over time. Because the monitoring in the present example was started just before 11:25:15 and occurs in real time, there is no data to graph before the start time.

The indicators 3306-3316 may use colors and/or other representations to indicate a particular state. For example, a currently active circuit may have a green indicator, while an inactive circuit may have a red or gray indicator. In addition, the size of a symbol (e.g., a lightning bolt) may scale based on the corresponding amperage, with higher levels of amperage having larger symbols. For example, the 9.8 amps of the indicator 3314 is represented by a visually smaller lightning bolt than the higher 17.6 amps of the indicator 3312. Such visual indications may provide an easily readable overview of the current state of each of the circuits 3104a-3104f.

The GUI 3300 also illustrates three indicators that provide real time performance information on the device 3102. More specifically, an indicator 3318 represents the current CPU usage of the device 3102 as 41.9%. An indicator 3320 represents the current disk usage (e.g., the amount of available disk space being used) of the device 3102 as 39.7%. An indicator 3322 represents the current memory usage of the device 3102 as 26.6%.

Referring specifically to FIG. 33B, the graphs 3302 and 3304 have scaled with respect to time. For example, the current scale is now in one minute increments rather than the fifteen second increments of FIG. 33A. This scaling enables a larger timeframe to be displayed and provides a longer term view of the amperage values for each circuit 3104a-3104f The graphs 3302 and 3304 may also smooth the lines as more data becomes available.

As shown by the indicator 3316, the circuit 3104f is not currently active. It is noted that the indicator is not showing minimal current or even zero current, it is showing that there is no reading at all. The graph 3304 reveals that sensor data was last received for the panel PP2-C from the sensor 3106f at approximately 11:31. The last reading of the circuit 3104f showed approximately thirteen amps. The lack of current sensor data may be due to a malfunction in the circuit 3104f or the sensor 3106f, and/or one or more other problems.

The real time data obtained by the NIO platform 402 can be used to proactively diagnose problems and, when a problem occurs, to react in real time. For example, the rise in current just after 11:29 and the subsequent fall just before 11:31 may have indicated a developing problem. If the NIO platform 402 was configured to monitor for such problems, it might have shut down the circuit 3106f before failure occurred or might have shut down one or more devices attached to the circuit to reduce the load. The NIO platform 402 may also be configured with information regarding the expected load levels to determine if the load level is within bounds during a spike. Alternatively or additionally, a more detailed level of monitoring may be started when a defined threshold is surpassed.

If configured to send alerts, the NIO platform 402 (or another NIO platform) could respond to this failure in real time by sending a message and/or taking other action. For example, if an actuation response is defined, the NIO platform 402 could activate an audible or visual alarm.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. The NIO platform architecture, including services and blocks, and/or any of the methods, sequence diagrams, and/or processes described herein may be embodied as instructions on a computer readable medium and distributed through physical media, by download, and/or provided as software as a service. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a software platform having services that can be configured for communications on a per service basis includes a core that interacts with an operating system on a device on which the core is run and is configured to run a plurality of services on the device; a plurality of blocks, wherein each of the blocks is based on a base block class and is customized with task specific processing functionality that can be executed only through one of the plurality of services; the plurality of services, wherein each of the services is based on a base service class and is configured to run at least some of the plurality of blocks within a mini runtime environment provided by the service in order to use the blocks' task specific processing functionality, and wherein each service is individually configured with an input block and an output block that define how the service receives and sends information, respectively; and at least one configuration file that defines the services to be run by the core, defines the blocks to be run by each of the services, and defines an order of execution of the blocks within each of the services.

In some embodiments, the at least one configuration file further defines a configuration of each of the input blocks and each of the output blocks.

In some embodiments, the configuration of each of the input blocks defines an input source for each of the input blocks and wherein the configuration of each of the output blocks defines an output destination for each of the output blocks.

In some embodiments, the input source defined for at least one of the input blocks identifies an output provided by one of the plurality of services.

In some embodiments, the input source defined for at least one of the input blocks identifies an output provided by one of a second plurality of services running on another software platform that includes a second core, a second plurality of blocks, and a second plurality of services.

In some embodiments, the output destination defined for at least one of the output blocks provides an input to one of the plurality of services.

In some embodiments, the output destination defined for at least one of the output blocks provides an input to one of a second plurality of services running on another software platform that includes a second core, a second plurality of blocks, and a second plurality of services.

In some embodiments, at least a first service of the plurality of services is configured with a first input block and a second input block, wherein the first input block contains task specific processing functionality for receiving input information of a first input type for the service and the second input block contains task specific processing functionality for receiving input information of a second input type for the service.

In some embodiments, at least a first service of the plurality of services is configured with a first input block and a second input block, wherein the first input block is configured to receive input information from a first input source for the service and the second input block is configured to receive input information from a second input source for the service.

In some embodiments, the input block of a first service of the plurality of services contains task specific processing functionality for receiving input information of a plurality of input types for the service.

In some embodiments, the input block of a first service of the plurality of services is configured to receive input information from a plurality of input sources.

In some embodiments, at least a first service of the plurality of services is configured with a first output block and a second output block, wherein the first output block contains task specific processing functionality for sending output information of a first output type for the service and the second output block contains task specific processing functionality for sending output information of a second output type for the service.

In some embodiments, at least a first service of the plurality of services is configured with a first output block and a second output block, wherein the first output block is configured to send output information to a first output destination for the service and the second output block is configured to send output information to a second output destination for the service.

In some embodiments, the output block of a first service of the plurality of services contains task specific processing functionality for sending output information of a plurality of output types for the service.

In some embodiments, the output block of a first service of the plurality of services is configured to send output information to a plurality of output destinations.

In another embodiment, a software platform having services that can be configured for communications on a per service basis includes a core that interacts with an operating system on a device on which the core is run and is configured to run a service on the device; a plurality of blocks, wherein each of the blocks is based on a base block class and is customized with task specific processing functionality that can be executed only through the service; the service, wherein the service is configured to run the blocks in order to use the blocks' task specific processing functionality, and wherein the service is configured with at least one input block to receive input information for the service and at least one output block to send output information from the service; and at least one configuration file that defines an order of execution of the blocks within the service and defines a configuration of the input block and the output block.

In some embodiments, the service is configured with a first input block and a second input block, wherein the first input block contains task specific processing functionality for receiving input information of a first input type for the service and the second input block contains task specific processing functionality for receiving input information of a second input type for the service.

In some embodiments, the service is configured with a first input block and a second input block, wherein the first input block is configured to receive input information from a first input source for the service and the second input block is configured to receive input information from a second input source for the service.

In some embodiments, the input block contains task specific processing functionality for receiving input information of a plurality of input types for the service.

In some embodiments, the input block is configured to receive input information from a plurality of input sources.

In some embodiments, the service is configured with a first output block and a second output block, wherein the first output block contains task specific processing functionality for sending output information of a first output type for the service and the second output block contains task specific processing functionality for sending output information of a second output type for the service.

In some embodiments, the service is configured with a first output block and a second output block, wherein the first output block is configured to send output information to a first output destination for the service and the second output block is configured to send output information to a second output destination for the service.

In some embodiments, the output block contains task specific processing functionality for sending output information of a plurality of output types for the service.

In some embodiments, the output block is configured to send output information to a plurality of output destinations.

In another embodiment, a software platform having services that can be configured for communications on a per service basis includes a core that interacts with an operating system on a device on which the core is run and is configured to run a plurality of services on the device; a plurality of blocks, wherein each of the blocks is based on a base block class and is customized with task specific processing functionality that can be executed only through one of the plurality of services; the plurality of services, wherein each of the services is based on a base service class and is configured to run at least some of the plurality of blocks within a mini runtime environment provided by the service in order to use the blocks' task specific processing functionality, and wherein an input type and an output type of each service are individually configurable on a per service basis as defined by the task specific processing functionality of at least one input block and at least one output block, respectively, that are to be run by the service; and at least one configuration file that defines the services to be run by the core, defines the blocks to be run by each of the services, defines an order of execution of the blocks within each of the services, and defines a configuration of each of the input blocks and the output blocks.

In another embodiment, a method for configuring a software platform for communications on a per service basis includes, for each of a plurality of services to be run on the software platform, selecting an input type for the service and an output type for the service; configuring the service with an input block corresponding to the input type selected for the service and an output block corresponding to the output type selected for the service, wherein configuring the service results in a service configuration; setting a first configurable parameter for the input block, wherein setting the first configurable parameter results in an input block configuration; setting a second configurable parameter for the output block, wherein setting the second configurable parameter results in an output block configuration; saving the service configuration, the input block configuration, and the output block configuration, wherein the service will run the input block and the output block within a mini runtime environment provided by the service.

In some embodiments, the method further includes loading the service configuration, the input block configuration, and the output block configuration for each of the plurality of services to a memory accessible by the software platform.

In some embodiments, the method further includes starting a core of the software platform to start the plurality of services, wherein the core uses the service configuration, the input block configuration, and the output block configuration of each of the plurality of services to start the corresponding service.

In another embodiment, a method for execution by a configurable software platform includes starting a core server that forms a base of the software platform; starting and configuring a plurality of services using the core server, wherein each service is configured to run an input block that identifies an input channel by which the service is to receive information and an output block that identifies an output channel by which the service is to send information; and for each service, starting and configuring the input block to receive information via the input channel and the output block to send information via the output channel, wherein the service runs the input block and the output block within a mini runtime environment provided by the service.

In some embodiments, configuring the plurality of services includes applying configuration information loaded into the software platform to each service after the service is started.

In some embodiments, configuring the input block and the output block for each service includes applying configuration information loaded into the software platform to each of the input block and the output block.

In another embodiment, a software platform having services that can be configured for communications on a per service basis includes a core that is designed to run on a device and launch a plurality of services; and the plurality of services, wherein each service provides a mini runtime environment for a plurality of blocks that provide specific functionality to the service, and wherein the services each include at least one input block that can be configured to receive data from any source from which the device is able to receive an input signal; and at least one output block that can be configured to send data to any destination to which the device is able to send an output signal.

In another embodiment, a system of software platforms includes a first software platform having a first core that is designed to run on a first device and launch a plurality of first services, wherein each of the first services provides a mini runtime environment for a plurality of blocks that provide specific functionality to the first service, and wherein each of the first services includes at least one input block that can be configured to receive data from any source from which the first device is able to receive an input signal and at least one output block that can be configured to send data to any destination to which the first device is able to send an output signal; and a second software platform having a second core that is designed to run on a second device and launch a plurality of second services, wherein each of the second services provides a mini runtime environment for a plurality of blocks that provide specific functionality to the second service, and wherein each of the second services includes at least one input block that can be configured to receive data from any source from which the second device is able to receive an input signal and at least one output block that can be configured to send data to any destination to which the second device is able to send an output signal, wherein at least one of the first services is configured to communicate with at least one of the second services.

In some embodiments, the first service and the second service communicate via a broker accessible by the first service and the second service.

In some embodiments, the first service and the second service communicate directly via service specific information provided to the input and output blocks of the first service and the second service.

In another embodiment, a method for creating a system of distributed services that can be deployed within differently configured hardware environments includes identifying a plurality of functions to be performed by the system; identifying a plurality of blocks needed to provide the plurality of functions; assigning each of the blocks to at least one of a plurality of services, wherein each service provides a mini-runtime environment within which the blocks assigned to the service are to be run, and wherein assigning the blocks results in a system configuration; and saving the system configuration to a memory for later deployment as a system of distributed services.

In some embodiments, the method further includes assigning each of the services to one of a plurality of software platform instances, wherein each software platform instance is to be located on a device within a hardware environment to which the system is being deployed.

In some embodiments, the method further includes saving the assignment of the services to the software platform instances in the system configuration.

In some embodiments, the method further includes selecting an input communications type and an output communications type for each of the services, wherein the selecting is based at least partially on the platform instance to which the service is assigned; and configuring each of the services to communicate using at least one input block corresponding to the input communications type and one output block corresponding to the output communications type, wherein the platform instances can be deployed to the hardware environment to be run.

In some embodiments, the method further includes determining that a first service of the plurality of services should be distributed; and separating the first service into a second service and a third service, wherein the second service is to be deployed to a first software platform instance on a first device within the hardware environment and the third service is to be deployed to a second device within the hardware environment.

In some embodiments, separating the first service into the second service and the third service includes: creating the second service to include the input block of the first service and adding a new output block; and creating the third service to include the output block of the first service and adding a new input block that is compatible with the new output block of the second service, wherein output from the new output block of the second service will be received by the new input block of the third service.

In some embodiments, the method further includes determining a number of the software platform instances to be used for the system; and assigning each of the software platform instances to a device within the hardware environment.

In some embodiments, the method further includes identifying a processing capability of each device that is available to run one or more of the software platform instances within the hardware environment, wherein the processing capability is used when assigned each software platform instance to one of the devices.

In some embodiments, the method further includes defining a communications cluster that enables a publication/subscription model, wherein at least a portion of the software platform instances are assigned to the communications cluster, and wherein a broker is located on one of the software platform instances to manage the publication/subscription model.

In some embodiments, intra-cluster communications between the services running on the software platform instances within the cluster use the publication/subscription model.

In some embodiments, the method further includes creating at least a portion of the blocks.

In some embodiments, the method further includes deploying the system configuration to a hardware environment.

In another embodiment, a method for creating a service that can be deployed within differently configured hardware environments includes identifying a plurality of functions to be performed by the system; identifying a plurality of blocks needed to provide the plurality of functions; assigning each of the blocks to a service, wherein the service provides a mini-runtime environment within which the blocks assigned to the service are to be run, and wherein assigning the blocks results in a system configuration; and saving the system configuration to a memory for later deployment.

In another embodiment, a method for creating a system of distributed services that can be deployed within differently configured hardware environments includes identifying a defined set of functions to be deployed, wherein the defined set of functions is embodied in a plurality of blocks; identifying a hardware environment within which the defined set of functions is to be deployed, wherein the identifying includes determining a processing capability of each of a plurality of devices within the hardware environment; determining a distribution of the blocks across at least some of the devices; grouping the blocks into a plurality of services based on how the blocks are to be distributed, wherein each service provides a mini-runtime environment for the blocks that are to be run by the service; and assigning each of the services to a software platform instance on the device where the blocks to be run by the service are to be located, wherein the software platform instance is configured to facilitate the services.

In another embodiment, a method for deploying a defined set of functions within differently configured hardware environments includes identifying a hardware environment within which the defined set of functions is to be deployed, wherein the identifying includes determining a processing capability of each of a plurality of devices within the hardware environment; selecting a plurality of blocks embodying the defined set of functions; grouping the blocks into a plurality of services, wherein each service provides a mini-runtime environment for the blocks that are to be run by the service; determining a distribution of the services across at least some of the devices; and assigning each of the services to a software platform on the device where the service is to be located, wherein the software platform is configured to facilitate the running of the services.

In some embodiments, the method further includes configuring at least one of the services and blocks after the services and blocks are deployed to the devices.

In some embodiments, the method further includes configuring at least one of the services and blocks before the services and blocks are deployed to the devices.

In another embodiment, a method for deploying a system configuration includes selecting a system configuration that defines a plurality of services, a plurality of blocks, and a relationship between the services and the blocks, wherein each service provides a mini-runtime environment for the blocks that are to be run by the service; identifying a hardware environment within which the system configuration is to be deployed, wherein the identifying includes determining a processing capability of each of a plurality of devices within the hardware environment; determining a distribution of the services across at least some of the devices; and assigning each of the services to a software platform on the device where the service is to be located, wherein the software platform is configured to facilitate the running of the services.

In some embodiments, the method further includes removing at least a first service from the system configuration, wherein the first service is not to be deployed to the hardware environment.

In some embodiments, the method further includes adding at least a first service to the system configuration, wherein the first service is to be deployed to the hardware environment.

In some embodiments, the method further includes placing at least one of the blocks to be run by the first service in another of the services that is to be deployed to the hardware environment.

In some embodiments, the method further includes reorganizing the relationship between at least some of the services and the blocks before the system configuration is deployed to the hardware environment.

In some embodiments, the method further includes configuring at least one of the services and blocks before deploying the system configuration to the hardware environment.

In some embodiments, the method further includes configuring at least one of the services and blocks after deploying the system configuration to the hardware environment.

In another embodiment, a system for monitoring and executing actions in real time with respect to electrical components includes a configurable platform having a core that is configured to interact with an operating system of a device on which the configurable platform is running, wherein the core is configured to run at least one service that controls a plurality of blocks for the configurable platform, and wherein each block operates asynchronously with respect to the other blocks within a mini runtime environment provided by the service and includes a set of platform specific instructions that enable the block to operate within the configurable platform and a set of task specific instructions that enable the block to perform a specific task within the configurable platform, wherein the blocks controlled by the at least one service include task specific instructions for: reading a value from each of a plurality of sensors coupled to a corresponding plurality of electrical components that are external to the device; determining, for at least one of the values, whether an actuation should occur; and performing the actuation if the determining indicates that the actuation should occur, wherein the steps of reading, determining, and performing occur without storing the values in a persistent memory.

In some embodiments, the at least one service controls the blocks by receiving output from a first block of the plurality of blocks and directing the output to a second block of the plurality of blocks.

In some embodiments, the service directs the output from the first block to the second block based on a routing table.

In some embodiments, the system further includes at least one configuration file that defines the least one service to be run by the core and defines a configuration of each of the blocks to be controlled by the at least one service.

In some embodiments, the blocks controlled by the at least one service include task specific instructions for: determining, for at least one of the values, that a message should be sent to a destination that is external to the configurable platform; and sending the message to the destination.

In some embodiments, the destination is on the device.

In some embodiments, the destination is external to the device.

In some embodiments, the destination is another configurable platform.

In some embodiments, the message is sent using a publish/subscribe channel.

In some embodiments, the message is sent as a hypertext transfer protocol message.

In some embodiments, the blocks controlled by the at least one service include task specific instructions for formatting the message as an alert message.

In some embodiments, the blocks controlled by the at least one service include task specific instructions for: formatting at least one of the values to create a formatted value to be used in visualizing the value; and inserting the formatted value into the message.

In some embodiments, the blocks controlled by the at least one service include task specific instructions for storing at least one of the values in a database, wherein the storing occurs in parallel with or following the steps of reading, determining, and performing and does not impact the real time occurrence of the steps of reading, determining, and performing.

In some embodiments, the blocks controlled by the at least one service include a first block customized to read analog sensor data from the plurality of sensors.

In some embodiments, the values are current values.

In some embodiments, the values are voltage values.

In some embodiments, the values are temperature values.

In some embodiments, at least one of the electrical components is a circuit in a power panel.

In some embodiments, the at least one of the electrical components is a consumer appliance.

In some embodiments, the consumer appliance is one of a stove, an oven, a coffee maker, a microwave, a toaster, a refrigerator, a television, a stereo system, a game console, a personal computer, a washing machine, and a dryer.

In some embodiments, the consumer appliance is one of a motion detector, a light socket, a light bulb, a light switch, a lighting device, a camera, an infrared detector, a hot water heater, a door lock, a window lock, a carbon monoxide sensor, a moisture sensor, and a heating, ventilation, and air conditioning (HVAC) system.

In some embodiments, the electrical components are located in an industrial environment.

In some embodiments, the electrical components are located in a retail environment.

In some embodiments, the electrical components are located in a vehicle.

In another embodiment, a system for monitoring and executing actions in real time with respect to electrical components includes a plurality of configurable platforms, wherein each configurable platform has a core that is configured to interact with an operating system of a device on which the configurable platform is running, wherein the core is configured to run at least one service that controls a plurality of blocks for the configurable platform, and wherein each block operates asynchronously with respect to the other blocks within a mini runtime environment provided by the service and includes a set of platform specific instructions that enable the block to operate within the configurable platform and a set of task specific instructions that enable the block to perform a specific task within the configurable platform, wherein the blocks controlled by the services of the configurable platforms include task specific instructions for: reading a value from each of a plurality of sensors coupled to a corresponding plurality of electrical components that are external to the device; determining, for at least one of the values, whether an actuation should occur; and performing the actuation if the determining indicates that the actuation should occur, wherein the steps of reading, determining, and performing occur without storing the values in a persistent memory.

In some embodiments, a first configurable platform of the plurality of configurable platforms is located on an edge device and configured with a first service to read the value from one of the plurality of sensors and send the value to a second configurable platform of the plurality of configurable platforms, and wherein the second configurable platform is located on an edge device and is configured with a second service to receive the value from the first service and perform the actuation on a first external device coupled to the second configurable platform.

In some embodiments, a first configurable platform of the plurality of configurable platforms is located on an edge device and configured with a first service to read the value from the sensor and send the value to a second configurable platform of the plurality of configurable platforms, and wherein the second configurable platform is located on a non-edge device and is configured with a second service to receive the value from the first service and send the value for display.

In some embodiments, each of the services uses a routing table to direct output from one block to another block within the service.

In some embodiments, the system further includes at least one configuration file corresponding to each of the plurality of configurable platforms, wherein the configuration file defines the at least one service to be run by the core and defines a configuration of each of the blocks to be controlled by the at least one service of the corresponding configurable platform.

In some embodiments, the blocks controlled by the services include task specific instructions for: determining, for at least one of the values, that a message should be sent to a destination that is external to the configurable platform; and sending the message to the destination.

In some embodiments, the destination is on the device.

In some embodiments, the destination is external to the device.

In some embodiments, the destination is another configurable platform.

In some embodiments, the message is sent using a publish/subscribe channel.

In some embodiments, the message is sent as a hypertext transfer protocol message.

In some embodiments, the blocks controlled by the services include task specific instructions for formatting the message as an alert message.

In some embodiments, the blocks controlled by the at least one service include task specific instructions for: formatting at least one of the values to create a formatted value to be used in visualizing the value; and inserting the formatted value into the message.

In some embodiments, the blocks controlled by the at least one service include task specific instructions for storing at least one of the values in a database, wherein the storing occurs in parallel with or following the steps of reading, determining, and performing and does not impact the real time occurrence of the steps of reading, determining, and performing.

In some embodiments, the blocks controlled by the at least one service include a first block customized to read analog sensor data from the plurality of sensors

In some embodiments, the values are current values.

In some embodiments, the values are voltage values.

In some embodiments, the values are temperature values.

In some embodiments, at least one of the electrical components is a circuit in a power panel.

In some embodiments, the at least one of the electrical components is a consumer appliance.

In some embodiments, the consumer appliance is one of a stove, an oven, a coffee maker, a microwave, a toaster, a refrigerator, a television, a stereo system, a game console, a personal computer, a washing machine, and a dryer.

In some embodiments, the consumer appliance is one of a motion detector, a light socket, a light bulb, a light switch, a lighting device, a camera, an infrared detector, a hot water heater, a door lock, a window lock, a carbon monoxide sensor, a moisture sensor, and a heating, ventilation, and air conditioning (HVAC) system.

In some embodiments, the electrical components are located in an industrial environment.

In some embodiments, the electrical components are located in a retail environment.

In some embodiments, the electrical components are located in a vehicle.

In some embodiments, a method for monitoring and executing actions in real time with respect to electrical components includes reading a value from each of a plurality of sensors coupled to a corresponding plurality of electrical components; determining, for at least one of the values, whether an actuation should occur; and performing the actuation if the determining indicates that the actuation should occur, wherein the steps of reading, determining, and performing occur without storing the values in a persistent memory.

In some embodiments, reading the value from each of the plurality of sensors is performed using a first block run by a service of a configurable platform.

In some embodiments, the method further includes passing, by the service, one of the values from the first block to a second block, wherein the second block performs the step of determining.

In some embodiments, the method further includes passing, by the service, one of the values to another service to perform the step of determining.

In some embodiments, the method further includes formatting the at least some of the values for display on a graphical user interface.

In some embodiments, the values are streamed for display in real time after the formatting.

1. A software platform having services that can be configured for communications on a per service basis, the software platform comprising:
a core that interacts with an operating system on a device on which the core is run and is configured to run a plurality of services on the device;
a plurality of blocks, wherein each of the blocks is based on a base block class and is customized with task specific processing functionality that can be executed only through one of the plurality of services;
the plurality of services, wherein each of the services is based on a base service class and is configured to run at least some of the plurality of blocks within a mini runtime environment provided by the service in order to use the blocks' task specific processing functionality, and wherein each service is individually configured with an input block and an output block that define how the service receives and sends information, respectively; and
at least one configuration file that defines the services to be run by the core, defines the blocks to be run by each of the services, and defines an order of execution of the blocks within each of the services.

2. The software platform of claim 1 wherein the at least one configuration file further defines a configuration of each of the input blocks and each of the output blocks.

3. The software platform of claim 2 wherein the configuration of each of the input blocks defines an input source for each of the input blocks and wherein the configuration of each of the output blocks defines an output destination for each of the output blocks.

4. The software platform of claim 3 wherein the input source defined for at least one of the input blocks identifies an output provided by one of the plurality of services.

5. The software platform of claim 3 wherein the input source defined for at least one of the input blocks identifies an output provided by one of a second plurality of services running on another software platform that includes a second core, a second plurality of blocks, and a second plurality of services.

6. The software platform of claim 3 wherein the output destination defined for at least one of the output blocks provides an input to one of the plurality of services.

7. The software platform of claim 3 wherein the output destination defined for at least one of the output blocks provides an input to one of a second plurality of services running on another software platform that includes a second core, a second plurality of blocks, and a second plurality of services.

8. The software platform of claim 1 wherein at least a first service of the plurality of services is configured with a first input block and a second input block, wherein the first input block contains task specific processing functionality for receiving input information of a first input type for the service and the second input block contains task specific processing functionality for receiving input information of a second input type for the service.

9. The software platform of claim 1 wherein at least a first service of the plurality of services is configured with a first input block and a second input block, wherein the first input block is configured to receive input information from a first input source for the service and the second input block is configured to receive input information from a second input source for the service.

10. The software platform of claim 1 wherein the input block of a first service of the plurality of services contains task specific processing functionality for receiving input information of a plurality of input types for the service.

11. The software platform of claim 1 wherein the input block of a first service of the plurality of services is configured to receive input information from a plurality of input sources.

12. The software platform of claim 1 wherein at least a first service of the plurality of services is configured with a first output block and a second output block, wherein the first output block contains task specific processing functionality for sending output information of a first output type for the service and the second output block contains task specific processing functionality for sending output information of a second output type for the service.

13. The software platform of claim 1 wherein at least a first service of the plurality of services is configured with a first output block and a second output block, wherein the first output block is configured to send output information to a first output destination for the service and the second output block is configured to send output information to a second output destination for the service.

14. The software platform of claim 1 wherein the output block of a first service of the plurality of services contains task specific processing functionality for sending output information of a plurality of output types for the service.

15. The software platform of claim 1 wherein the output block of a first service of the plurality of services is configured to send output information to a plurality of output destinations.

16. A method for configuring a software platform for communications on a per service basis, the method comprising:
for each of a plurality of services to be run on the software platform,
selecting an input type for the service and an output type for the service;
configuring the service with an input block corresponding to the input type selected for the service and an output block corresponding to the output type selected for the service, wherein configuring the service results in a service configuration;
setting a first configurable parameter for the input block, wherein setting the first configurable parameter results in an input block configuration;
setting a second configurable parameter for the output block, wherein setting the second configurable parameter results in an output block configuration;
saving the service configuration, the input block configuration, and the output block configuration, wherein the service will run the input block and the output block within a mini runtime environment provided by the service.

17. The method of claim 16 further comprising loading the service configuration, the input block configuration, and the output block configuration for each of the plurality of services to a memory accessible by the software platform.

18. The method of claim 17 further comprising starting a core of the software platform to start the plurality of services, wherein the core uses the service configuration, the input block configuration, and the output block configuration of each of the plurality of services to start the corresponding service.

19. A method for execution by a configurable software platform, the method comprising:
starting a core server that forms a base of the software platform;
starting and configuring a plurality of services using the core server, wherein each service is configured to run an input block that identifies an input channel by which the service is to receive information and an output block that identifies an output channel by which the service is to send information; and
for each service, starting and configuring the input block to receive information via the input channel and the output block to send information via the output channel, wherein the service runs the input block and the output block within a mini runtime environment provided by the service.
